(19) United States
(12) Patent Application Publication
(10) Pub. No.: US 2024/0088974 A1
(43) Pub. Date: Mar. 14, 2024

(54) BEAM INDICATION METHOD AND APPARATUS, AND BEAM DETERMINATION METHOD AND APPARATUS

(71) Applicant: Beijing Xiaomi Mobile Software Co., Ltd., Beijing (CN)

(72) Inventors: Xingyi LUO, Beijing (CN); Mingju LI, Beijing (CN)

(73) Assignee: Beijing Xiaomi Mobile Software Co., Ltd., Beijing (CN)

(21) Appl. No.: 18/272,284

(22) PCT Filed: Jan. 14, 2021
(86) PCT No.: PCT/CN2021/071944

§ 371 Date: Jul. 13, 2023

(51) Int. Cl. H04B 7/06; H04L 5/00

(52) U.S. Cl. CPC H04B 7/0695; H04L 5/0053

(57) ABSTRACT

A beam indication method includes: determining an uplink and downlink beam indication manner on the basis of a beam indication scheme which indicates that a data channel and a control channel share the same beam information; and on the basis of the uplink and downlink beam indication manner, sending beam information by using at least one of a MAC CE and DCI, thereby providing a beam indication method that can be used when a data channel and a control channel use a common beam indication.

### CROSS REFERENCE TO RELATED APPLICATION

The present application is a U.S. National Stage of International Application No. PCT/CN2021/071944, filed on Jan. 14, 2021, the entire content of which is incorporated herein by reference for all purposes.

### BACKGROUND

In a 5G NR system, beam management enhancement is proposed to support layer 1 (L1)/layer 2 (L2) (L1/L2)-centric inter-cell mobility. In the L1/L2-centric inter-cell mobility. When a terminal moves to an area covered by both a serving cell and an adjacent cell, the beam performance of the adjacent cell may be better than the beam performance of the serving cell at some moments due to dynamic changes of the beam performance of the serving cell and the adjacent cell.

### SUMMARY

In a first aspect of the present disclosure, the embodiment provides a beam indication method, performed by a network device and including: determining an uplink and downlink beam indication mode based on a beam indication solution for a terminal, where the beam indication solution indicates that a data channel and a control channel share same beam information; and transmitting, by at least one of a media access control control element (MAC CE) or downlink control information (DCI), the beam indication information to the terminal based on the uplink and downlink beam indication mode, where the beam indication information indicates a beam configured for the terminal.

In a second aspect of the present disclosure, the embodiment provides a beam determination method, performed by a terminal and including: receiving, by at least one of a media access control control element (MAC CE) or downlink control information (DCI), beam indication information, where the beam indication information indicates a beam configured for the terminal; determining an uplink and downlink beam indication mode based on a beam indication solution for the terminal, where the beam indication solution indicates that a data channel and a control channel share same beam information; and determining the beam information based on the uplink and downlink beam indication mode and the beam indication information.

In a third aspect of the present disclosure, the embodiment provides a beam determination method, performed by a terminal and including: receiving RRC configuration signaling including transmission configuration indication (TCI) state configuration information, where the TCI state configuration information includes an identifier used for distinguishing a serving cell and an adjacent cell of the terminal; and configuring beam-related information based on the RRC configuration signaling.

Additional aspects and advantages of the present disclosure will be set forth partially in the following description, which will become obvious in the following description, or can be learned by practice of the present disclosure.

### BRIEF DESCRIPTION OF THE DRAWINGS

The above and/or additional aspects and advantages of the present disclosure will become obvious and comprehensible from the description of examples in conjunction with the drawings.

FIG. 1 is a flow chart of a beam indication method according to an embodiment of the present disclosure.

FIG. 2 is a flow chart of a beam indication method according to an embodiment of the present disclosure.

FIG. 3 is a flow chart of a beam indication method according to an embodiment of the present disclosure.

FIG. 4 is a flow chart of a beam indication method according to an embodiment of the present disclosure.

FIG. 5 is a flow chart of a beam indication method according to an embodiment of the present disclosure.

FIG. 6 is a flow chart of a beam indication method according to an embodiment of the present disclosure.

FIG. 7 is a flow chart of a beam determination method according to an embodiment of the present disclosure.

FIG. 8 is a flow chart of a beam determination method according to an embodiment of the present disclosure.

FIG. 9 is a flow chart of a beam determination method according to an embodiment of the present disclosure.

FIG. 10 is a flow chart of a beam determination method according to an embodiment of the present disclosure.

FIG. 11 is a flow chart of a beam determination method according to an embodiment of the present disclosure.

FIG. 12 is a flow chart of a beam determination method according to an embodiment of the present disclosure.

FIG. 13 is a flow chart of a beam determination method according to an embodiment of the present disclosure.

FIG. 14 is a flow chart of a beam determination method according to an embodiment of the present disclosure.

FIG. 15 is a flow chart of a beam determination method according to an embodiment of the present disclosure.

FIG. 16 is a schematic structural diagram of a beam indication apparatus provided by an embodiment of the present disclosure.

FIG. 17 is a schematic structural diagram of a beam indication apparatus provided by an embodiment of the present disclosure.

FIG. 18 is a schematic structural diagram of a beam indication apparatus provided by an embodiment of the present disclosure.

FIG. 19 is a schematic structural diagram of a beam determination apparatus provided by an embodiment of the present disclosure.

FIG. 20 is a schematic structural diagram of a beam determination apparatus provided by an embodiment of the present disclosure.

FIG. 21 is a schematic structural diagram of a beam determination apparatus provided by an embodiment of the present disclosure.

FIG. 22 is a schematic structural diagram of a beam determination apparatus provided by an embodiment of the present disclosure.

FIG. 23 is a schematic structural diagram of a beam determination apparatus provided by an embodiment of the present disclosure.

FIG. 24 is a schematic structural diagram of a communication device provided by an embodiment of the present disclosure.

### DETAILED DESCRIPTION

The embodiments of the present disclosure are described in detail below. Examples of the embodiments are shown in the accompanying drawings, in which the same or similar reference numerals represent the same or similar elements with the same or similar functions. The embodiments described with reference to the accompanying drawings are illustrative and only intended to explain the present disclosure, instead of being construed as limiting the present disclosure.

The present disclosure relates to the technical field of mobile communication, and in particular to a beam indication method and apparatus, and a beam determination method and apparatus.

In a 5G new radio (NR) system, beam management enhancement is proposed to support L1/L2-centric inter-cell mobility. In the L1/L2-centric inter-cell mobility, when a terminal moves to an area covered by both a serving cell and an adjacent cell, the beam performance of the adjacent cell may be better than the beam performance of the serving cell at some moments due to dynamic changes of the beam performance of the serving cell and the adjacent cell. In this case, a beam of the adjacent cell is indicated for the terminal to provide a service for the terminal.

In addition, in the 5G NR system, a unified transmission configuration indication (TCI) framework is proposed, in which a data channel and a control channel share a common beam indication. However, the beam indication method under the unified TCI framework is not given at present.

The present application discloses a beam indication method and apparatus, and a beam determination method and apparatus, and provides a beam indication method that may be used in a case that a data channel and a control channel share a common beam indication and a method for indicating a beam of an adjacent cell for a terminal. Therefore, in case that the beam performance of the adjacent cell is good, the adjacent cell can provide a service for the terminal, and a throughput of the terminal is increased.

Techniques described herein are not limited to the 5th-generation (5G) mobile communication system, its advanced communication system, and an LTE/LTE advanced (LTE-A) system, and may further be used for various wireless communications systems such as code division multiple access (CDMA), time division multiple access (TDMA), frequency division multiple access (FDMA), orthogonal frequency division multiple access (OFDMA), single-carrier frequency-division multiple access (SC-FDMA), and other systems.

The terminal provided by the embodiments of the present invention may be a mobile phone, a tablet computer, a notebook computer, an ultra-mobile personal computer (UMPC), a netbook or a personal digital assistant (PDA), a mobile Internet device (MID), a wearable device, a vehicular device or the like.

In the communication system, a data channel and a control channel may be indicated by their own dedicated beams or by a common beam. However, at present, no specific beam indication mode has been proposed to achieve a common beam indication of the data channel and the control channel. For the beam indication method and apparatus and the beam determination method and apparatus provided by the embodiments of the present disclosure, the uplink and downlink beam indication mode is determined based on the beam indication solution indicating that the data channel and the control channel share the same beam information. The beam indication information is sent by at least one of the MAC CE or the DCI based on the uplink and downlink beam indication mode, so that the beam indication method that may be used in a case that the data channel and the control channel share the common beam indication is provided. In addition, by including the identifier differentiating the serving cell and the adjacent cell in the TCI state configuration information of the RRC configuration signaling, the beam of the adjacent cell can be indicated for the terminal. Thus, in case that the beam performance of the adjacent cell is good, the adjacent cell can provide a service for the terminal, and a throughput of the terminal is increased.

In the present application, the network device may be a base station which may include a plurality of cells providing services for a terminal device. According to different specific application scenarios, the base station may also be called an access point, or may be a device, that communicates with a wireless terminal device through one or more sectors on an air interface, in the access network, or other names.

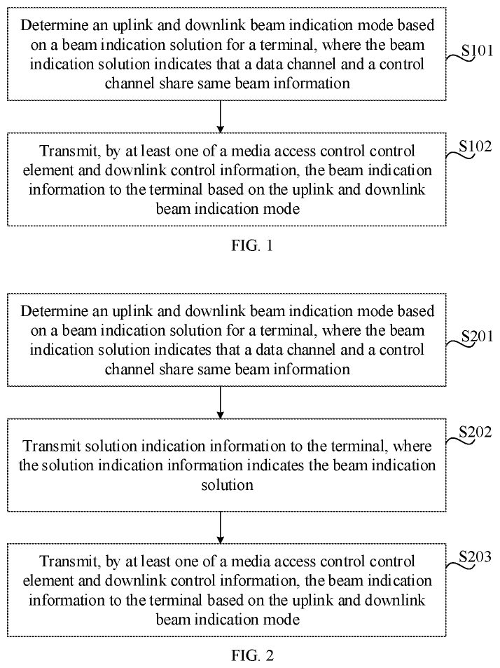

FIG. 1 is a flow chart of a beam indication method according to an embodiment of the present disclosure. In this embodiment, the method is executed by the network device. As shown in FIG. 1, the beam indication method includes the following steps S101 and S102.

In S101, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the network device may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication. In some embodiments, the uplink and downlink beam indication mode may be notified to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer.

Then in S102, transmit, by at least one of a media access control control element (MAC CE) or downlink control information (DCI), the beam indication information to the terminal based on the uplink and downlink beam indication mode, where the beam indication information indicates a beam configured for the terminal.

In this embodiment, in response to determining that the uplink and downlink beam indication mode, the network device may transmit the beam indication information to the terminal through the MAC CE and/or the DCI based on the uplink and downlink beam indication mode.

For the beam indication method according to this embodiment, the uplink and downlink beam indication mode is determined based on the beam indication solution indicating that the data channel and the control channel share the same beam information. And the beam indication information is sent by at least one of the MAC CE or the DCI based on the uplink and downlink beam indication mode, so that the beam indication method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

FIG. 2 is a flow chart of a beam indication method according to an embodiment of the present disclosure. In this embodiment, the method is executed by the network device. As shown in FIG. 2, the beam indication method includes the following steps S201-S203.

In S201, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the network device may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication. In some embodiments, the uplink and downlink beam indication mode may be notified to the terminal through the high layer signaling, that is, information identifying the uplink and downlink beam indication mode may be included in the high layer signaling. The high layer signaling may be signaling of other layers, for example, an RRC layer, a MAC layer or the like, except a physical layer.

Then in S202, transmit solution indication information to the terminal, where the solution indication information indicates the beam indication solution.

In this embodiment, the network device may transmit the solution indication information to the terminal, so as to notify the terminal of the beam indication solution, for example, through high layer signaling. The high layer signaling may be signaling of other layers, for example, an RRC layer, a MAC layer or the like, except a physical layer.

In some embodiments, the solution indication information further includes: information used for identifying a control resource set (CORESET) adapting to the beam indication solution.

The beam indication solution that the data channel and the control channel share the same beam information may not necessarily adapt to all physical downlink control channels. In this case, the high layer signaling may indicate that the beam indication solution adapts to which control resource set (CORESET).

Next in S203, transmit, by at least one of a media access control control element (MAC CE) or downlink control information (DCI), the beam indication information to the terminal based on the uplink and downlink beam indication mode, where the beam indication information indicates a beam configured for the terminal.

In this embodiment, after determining the uplink and downlink beam indication mode, the network device may transmit the beam indication information to the terminal through the MAC CE and/or the DCI based on the uplink and downlink beam indication mode.

For the beam indication method according to this embodiment, the uplink and downlink beam indication mode is determined based on the beam indication solution indicating that the data channel and the control channel share the same beam information; the beam indication solution is notified to the terminal; and the beam information is sent by at least one of the MAC CE or the DCI based on the uplink and downlink beam indication mode, so that the beam indication method that may be used in a case that the data channel and the control channel share the common beam indication is provided.

It should be noted that the above steps S201-S203 are not necessarily executed sequentially. For example, S202 may further be executed before S201 or after S203, and the like.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

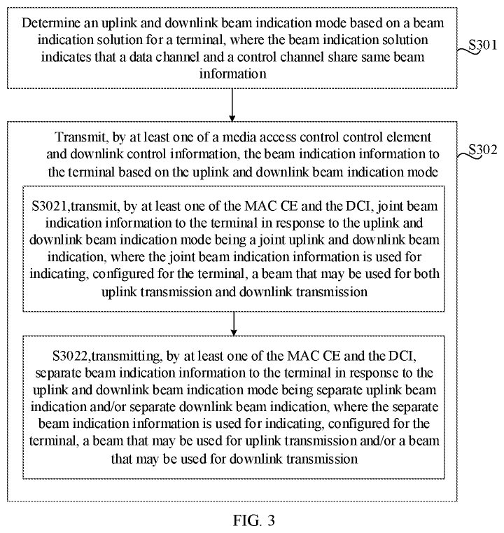

FIG. 3 is a flow chart of a beam indication method according to an embodiment of the present disclosure. In this embodiment, the method is executed by the network device. As shown in FIG. 3, the beam indication method includes the following steps S301 and S302.

In S301, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the network device may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication. In some embodiments, the uplink and downlink beam indication mode may be notified to the terminal through the high layer signaling, that is, information identifying the uplink and downlink beam indication mode may be included in the high layer signaling. The high layer signaling may be signaling of other layers, for example, an RRC layer, a MAC layer or the like, except a physical layer.

Then in S302, transmit, by at least one of a media access control control element (MAC CE) or downlink control information (DCI), the beam indication information to the terminal based on the uplink and downlink beam indication mode, where the beam indication information indicates a beam configured for the terminal.

In this embodiment, after determining the uplink and downlink beam indication mode, the network device may transmit the beam indication information to the terminal through the MAC CE and/or the DCI based on the uplink and downlink beam indication mode.

In some examples, the transmitting beam indication information to the terminal, S302 may include any of the following steps S3021 and S3022.

In S3021, transmit, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission.

In this embodiment, in case that the uplink and downlink beam indication mode is the joint uplink and downlink beam indication, the network device transmits the joint beam indication information to the terminal, to be used for indicating the beam that may be used for both uplink transmission and downlink transmission.

In some examples, the joint beam indication information may be sent to the terminal by any of the following modes.

Mode I, the MAC CE is sent to the terminal. Where the MAC CE indicates one TCI state which corresponds to the beam that may be used for both uplink transmission and downlink transmission. In general, each TCI state may correspondingly indicate one beam used for uplink and/or downlink transmission. Here, the MAC CE indicating the TCI state may represent that the MAC CE indicates the TCI state for the terminal to activate the TCI state.

In this embodiment, the network device may transmit the joint beam indication information through the MAC CE, Where the MAC CE indicates (for example, activates) one TCI state, the corresponding beam of which may be used for both uplink transmission and downlink transmission; and downlink transmission and uplink transmission use the same beam.

Mode II, the MAC CE and the DCI are sent to the terminal. Where the MAC CE indicates a plurality of TCI states, and a first indication field of the DCI includes a first field portion indicating one TCI state, corresponding to the beam that may be used for uplink transmission and also downlink transmission, in the plurality of TCI states.

In this embodiment, the network device may transmit the joint beam indication information through the MAC CE and the DCI, where the MAC CE indicates (for example, activates) a plurality of TCI states, and a first indication field of the DCI includes a first field portion indicating one TCI state, corresponding to the beam that may be used for downlink transmission and also uplink transmission, in the plurality of TCI states. For example, the DCI includes a TCI field, which includes a plurality of bits for indicating one TCI state. The corresponding beam of the TCI state may be used for downlink transmission and also uplink transmission. Therefore, in a case that the MAC CE activates a plurality of TCI states, one TCI state may be selected from the plurality of activated TCI states using the DCI, so as to indicate the beam that may be used for downlink transmission and also uplink transmission. An existing DCI format 1_1 and DCI format 1_2 may be reused. In one example, the TCI field in the DCI is fixed to include M bits for indicating one TCI state corresponding to the beam that may be used for downlink transmission and also uplink transmission. In another example, the TCI field in the DCI is fixed to include M+N bits, including M bits for indicating the TCI state corresponding to the beam that may be used for downlink transmission, and N bits for indicating the TCI state corresponding to the beam that may be used for uplink transmission. The M bits and the N bits may be distinguished by predetermined locations of the network device and the terminal. It should be noted that the TCI field of the DCI is not limited to the above description, for example, in some embodiments, the first M bits indicate an uplink transmission beam, and the last N bits indicate a downlink transmission beam, where the M bits and the N bits may indicate the same TCI state, so as to indicate the beam that may be used for downlink transmission and also uplink transmission.

Mode III, the DCI is sent to the terminal. Where the first indication field of the DCI includes a first field portion indicating one TCI state, corresponding to the beam that may be used for both uplink transmission and downlink transmission, in the plurality of activated TCI states.

In this embodiment, the network device may transmit the joint beam indication information through the DCI. In case that there is a need for a beam indication, it is possible to first determine whether a currently activated TCI state (for example, the TCI state activated by the previously sent MAC CE) is available. In case that there is a currently available activated TCI state, the network device may only transmit the DCI to the terminal, so as to indicate the beam. The first indication field of the DCI includes the first field portion indicating one TCI state, corresponding to the beam that may be used for downlink transmission and also uplink transmission, in the plurality of activated TCI states, where a specific example of the DCI may refer to the above description.

In some embodiments, the first indication field, sent to the terminal, of the DCI further includes: a second field portion indicating the uplink and downlink beam indication mode. Where the uplink and downlink beam indication mode is one of the joint uplink and downlink beam indication, a separate uplink beam indication and a separate downlink beam indication.

In this embodiment, in a case that the network device transmits the beam indication information through the MAC CE and the DCI, the first indication field of the DCI may include the first field portion and the second field portion, where the second field portion is used as an identifier for identifying that the TCI state indicated by the first field portion corresponds to which one of the beam that may be used for downlink transmission and also uplink transmission, the beam that may be used for downlink transmission, and the beam that may be used for uplink transmission. In response to the beam indication information being the joint beam indication information, the second field portion indicates the joint uplink and downlink beam indication, that is, used for indicating that the TCI state indicated by the first field portion corresponds to the beam that may be used for downlink transmission and also uplink transmission.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In response to the network device transmitting the joint beam indication information, the T identifiers indicate the joint uplink and downlink beam indication, while the max (M, N) bits indicate the TCI state corresponding to the beam that may be used for downlink transmission and also uplink transmission.

Then in S3022, transmit, by at least one of the MAC CE or the DCI, separate beam indication information to the terminal in response to the uplink and downlink beam indication mode being separate uplink beam indication and/or separate downlink beam indication, where the separate beam indication information is used for indicating, configured for the terminal, a beam that may be used for uplink transmission and/or a beam that may be used for downlink transmission.

In this embodiment, in case that the uplink and downlink beam indication mode is the separate uplink beam indication and/or separate downlink beam indication, the network device transmits the separate beam indication information to the terminal, to be used for indicating the beam that may be used for uplink transmission and/or the beam that may be used for downlink transmission.

In some examples, the separate beam indication information may be sent to the terminal by any of the following modes.

Mode I, at least one MAC CE is sent to the terminal. Where the at least one MAC CE includes a first MAC CE indicating one TCI state which corresponds to the beam that may be used for uplink transmission, and/or a second MAC CE indicating one TCI state which corresponds to the beam that may be used for downlink transmission.

In this embodiment, the network device may transmit the separate beam indication information through at least one MAC CE. Where one MAC CE may be used for indicating (for example, activating) one TCI state to correspond to the beam that may be used for uplink transmission, and/or another MAC CE may be used for indicating (for example, activating) one TCI state to correspond to the beam that may be used for downlink transmission.

Mode II, at least one MAC CE and the DCI are sent to the terminal. Where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In this embodiment, the network device may transmit the separate beam indication information through at least one MAC CE and the DCI, where the at least one MAC CE indicates (for example, activates) a plurality of TCI states, and a first indication field of the DCI includes a first field portion indicating one TCI state, corresponding to the beam that may be used for downlink transmission, and/or one TCI state, corresponding to the beam that may be used for uplink transmission, in the plurality of TCI states. For example, the DCI includes the TCI field, which includes a plurality of bits for indicating one TCI state, the corresponding beam of which may be used for downlink transmission, and/or one TCI state, the corresponding beam of which may be used for uplink transmission.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In this embodiment, the network device may transmit the separate beam indication information through the MAC CE and the DCI. In some examples, the MAC CE indicates (for example, activates) a plurality of TCI states corresponding to the beam that may be used for uplink transmission and a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the plurality of TCI states activated by the MAC CE may include the TCI state corresponding to the beam that may be used for uplink transmission and the TCI state corresponding to the beam that may be used for downlink transmission. In case that the MAC AC activates the plurality of such TCI states, the DCI is used to select the corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. For example, the DCI may reuse the existing DCI format 1_1 and DCI format 1_2, for example, the TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. It should be noted that the TCI field of the DCI is not limited to the above description. For example, in some embodiments, the first M bits indicate the uplink beam, while the last N bits indicate the downlink beam.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

In this embodiment, the network device may transmit the separate beam indication information through the MAC CE and the DCI. In some examples, the MAC CE includes a MAC CE indicating (for example, activating) a plurality of TCI states corresponding to the beam that may be used for uplink transmission, and a MAC CE indicating (for example, activating) a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the MAC CE may identify whether the activated TCI states correspond to the beam that may be used for downlink transmission or the beam that may be used for uplink transmission. For example, the plurality of TCI states corresponding to the beam that may be used for downlink transmission may be activated by one MAC CE; and the plurality of TCI states corresponding to the beam that may be used for uplink transmission may be activated by another MAC CE. Then, the DCI is used to select a corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. The existing DCI format 1_1 and DCI format 1_2 may be reused. The TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by the predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. However, for the DCI used for the separate uplink beam indication, values of the corresponding last N bits may be used. It should be noted that the TCI field of the DCI is not limited to the above description. For example, in some embodiments, the first M bits indicate the uplink beam, while the last N bits indicate the downlink beam.

Mode III, the DCI is sent to the terminal. Where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In this embodiment, the network device may transmit the separate beam indication information through the DCI. In a case that there is a need for a beam indication, it is possible to first determine whether a currently activated TCI state (for example, the TCI state activated by the previously sent MAC CE) is available. In case that there is a currently available activated TCI state, the network device may only transmit the DCI to the terminal, so as to indicate the beam. The first indication field of the DCI includes the first field portion indicating one TCI state, corresponding to the beam that may be used for uplink transmission, and/or one TCI state, corresponding to the beam that may be used for downlink transmission, in the plurality of activated TCI states. where a specific example of the DCI may refer to the above description.

In some embodiments, the first indication field, sent to the terminal, of the DCI further includes: a second field portion indicating the uplink and downlink beam indication mode. Where the uplink and downlink beam indication mode is one of the joint uplink and downlink beam indication, a separate uplink beam indication and a separate downlink beam indication.

In this embodiment, in a case that the network device transmits the beam indication information through the MAC CE and the DCI, the first indication field of the DCI may include the first field portion and the second field portion. Where the second field portion is used as an identifier for identifying that the TCI state indicated by the first field portion corresponds to which one of the beam that may be used for downlink transmission and also uplink transmission, the beam that may be used for downlink transmission, and the beam that may be used for uplink transmission. In response to the beam indication information being the separate beam indication information, the second field portion indicates the separate downlink beam indication (that is, used for indicating that the TCI state indicated by the first field portion corresponds to the beam that may be used for downlink transmission), or the separate uplink beam indication (that is, used for indicating that the TCI state indicated by the first field portion corresponds to the beam that may be used for uplink transmission).

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In case that the network device transmits the separate beam indication information through the MAC CE and the DCI, the T identifiers indicate the separate uplink beam indication or the separate downlink beam indication. For the DCI used for the separate downlink beam indication, the T identifiers indicate the separate downlink beam indication, while the max (M, N) bits indicate the TCI state corresponding to the beam that may be used for downlink transmission. For the DCI used for the separate uplink beam indication, the T identifiers indicate the separate uplink beam indication, while the max (M, N) bits indicate the TCI state corresponding to the beam that may be used for uplink transmission.

In the beam indication method according to this embodiment, in response to whether the uplink and downlink beam indication mode being the joint uplink and downlink beam indication or the separate uplink beam indication and/or separate downlink beam indication, the joint beam indication information or the separate beam indication information is sent by at least one of the MAC CE or the DCI, so that the beam indication method that may be used in the case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

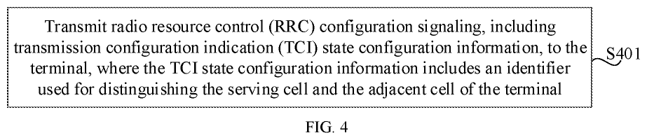

FIG. 4 is a flow chart of a beam indication method according to an embodiment of the present disclosure. In this embodiment, the method is executed by the network device. As shown in FIG. 4, the beam indication method includes the following step S401.

In S401, transmit radio resource control (RRC) configuration signaling, including transmission configuration indication (TCI) state configuration information, to the terminal, where the TCI state configuration information includes an identifier used for distinguishing a serving cell and an adjacent cell of the terminal.

In this embodiment, in order to distinguish the serving cell and the adjacent cell, the network device may introduce a new parameter upon using the RRC configuration signaling to configure the TCI state, and this parameter is used for distinguishing the serving cell and the adjacent cell. For example, for a case where the data channel and the control channel share the common beam indication, neighborcellindex is introduced to distinguish the serving cell and the adjacent cell in the case that the RRC configuration signaling is used to configure an uplink TCI state and a downlink TCI state. For a case where the data channel and the control channel use dedicated beam indications, neighborcellindex is introduced to distinguish the serving cell and the adjacent cell in a case that the RRC configuration signaling is used to configure the TCI state and a spatial relation.

In the beam indication method according to this embodiment, by including the identifier differentiating the serving cell and the adjacent cell in the TCI state configuration information of the RRC configuration signaling, the beam of the adjacent cell can be indicated for the terminal. Thus, in case that the beam performance of the adjacent cell is good, the adjacent cell can provide the service for the terminal, and the throughput of the terminal is increased.

In some embodiments, the identifier includes a physical cell identify (PCI) of the adjacent cell.

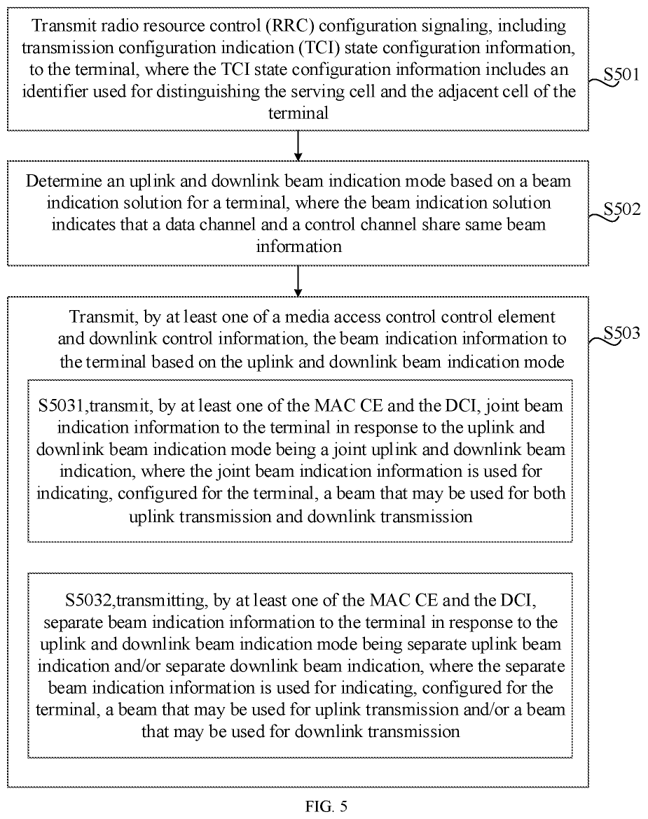

FIG. 5 is a flow chart of a beam indication method according to an embodiment of the present disclosure. In this embodiment, the method is executed by the network device. As shown in FIG. 5, the beam indication method includes the following steps S501-S503.

In S501, transmit radio resource control (RRC) configuration signaling, including transmission configuration indication (TCI) state configuration information, to the terminal, where the TCI state configuration information includes an identifier used for distinguishing a serving cell and an adjacent cell of the terminal.

In this embodiment, in order to distinguish the serving cell and the adjacent cell, the network device may introduce a new parameter upon using the RRC configuration signaling to configure the TCI state, and this parameter is used for distinguishing the serving cell and the adjacent cell.

In some embodiments, the identifier includes a physical cell identify (PCI) of the adjacent cell.

Then in S502, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the network device may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication. In some embodiments, the uplink and downlink beam indication mode may be notified to the terminal through the high layer signaling, that is, information identifying the uplink and downlink beam indication mode may be included in the high layer signaling. The high layer signaling may be signaling of other layers, for example, an RRC layer, a MAC layer or the like, except a physical layer.

Then in S503, transmit, by at least one of a media access control control element (MAC CE) or downlink control information (DCI), the beam indication information to the terminal based on the uplink and downlink beam indication mode, where the beam indication information indicates a beam configured for the terminal.

In this embodiment, after determining the uplink and downlink beam indication mode, the network device may transmit the beam indication information to the terminal through the MAC CE and/or the DCI based on the uplink and downlink beam indication mode.

In some examples, the transmitting beam indication information to the terminal, S503 may include any of the following steps S5031 and S5032.

S5031, transmitting, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission.

In this embodiment, in case that the uplink and downlink beam indication mode is the joint uplink and downlink beam indication, the network device transmits the joint beam indication information to the terminal, to be used for indicating the beam that may be used for both uplink transmission and downlink transmission.

In some examples, the joint beam indication information may be sent to the terminal by any of the following modes.

Mode I, the MAC CE is sent to the terminal. Where the MAC CE indicates one TCI state which corresponds to the beam that may be used for both uplink transmission and downlink transmission. In general, each TCI state may correspondingly indicate one beam used for uplink and/or downlink transmission. Here, the MAC CE indicating the TCI state may represent that the MAC CE indicates the TCI state for the terminal to activate the TCI state.

In this embodiment, the network device may transmit the joint beam indication information through the MAC CE, where the MAC CE indicates (for example, activates) one TCI state, the corresponding beam of which may be used for both uplink transmission and downlink transmission; and downlink transmission and uplink transmission use the same beam.

Mode II, the MAC CE and the DCI are sent to the terminal. Where the MAC CE indicates a plurality of TCI states, and a first indication field of the DCI includes a first field portion indicating one TCI state, corresponding to the beam that may be used for uplink transmission and also downlink transmission, in the plurality of TCI states.

In this embodiment, the network device may transmit the joint beam indication information through the MAC CE and the DCI, where the MAC CE indicates (for example, activates) a plurality of TCI states, and a first indication field of the DCI includes a first field portion indicating one TCI state, corresponding to the beam that may be used for downlink transmission and also uplink transmission, in the plurality of TCI states. For example, the DCI includes a TCI field, which includes a plurality of bits for indicating one TCI state. The corresponding beam of the TCI state may be used for downlink transmission and also uplink transmission. Therefore, in a case that the MAC CE activates a plurality of TCI states, one TCI state may be selected from the plurality of activated TCI states using the DCI, so as to indicate the beam that may be used for downlink transmission and also uplink transmission. An existing DCI format 1_1 and DCI format 1_2 may be reused. In one example, the TCI field in the DCI is fixed to include M bits for indicating one TCI state corresponding to the beam that may be used for downlink transmission and also uplink transmission. In another example, the TCI field in the DCI is fixed to include M+N bits, including M bits for indicating the TCI state corresponding to the beam that may be used for downlink transmission, and N bits for indicating the TCI state corresponding to the beam that may be used for uplink transmission. The M bits and the N bits may be distinguished by predetermined locations of the network device and the terminal. It should be noted that the TCI field of the DCI is not limited to the above description, for example, in some embodiments, the first M bits indicate an uplink transmission beam, and the last N bits indicate a downlink transmission beam, where the M bits and the N bits may indicate the same TCI state, so as to indicate the beam that may be used for downlink transmission and also uplink transmission.

Mode III, the DCI is sent to the terminal, where the first indication field of the DCI includes a first field portion indicating one TCI state, corresponding to the beam that may be used for both uplink transmission and downlink transmission, in the plurality of activated TCI states.

In this embodiment, the network device may transmit the joint beam indication information through the DCI. In case that there is a need for a beam indication, it is possible to first determine whether a currently activated TCI state (for example, the TCI state activated by the previously sent MAC CE) is available. In case that there is a currently available activated TCI state, the network device may only transmit the DCI to the terminal, so as to indicate the beam. The first indication field of the DCI includes the first field portion indicating one TCI state, corresponding to the beam that may be used for downlink transmission and also uplink transmission, in the plurality of activated TCI states, where a specific example of the DCI may refer to the above description.

In some embodiments, the first indication field, sent to the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In this embodiment, in a case that the network device transmits the beam indication information through the MAC CE and the DCI, the first indication field of the DCI may include the first field portion and the second field portion, where the second field portion is used as an identifier for identifying that the TCI state indicated by the first field portion corresponds to which one of the beam that may be used for downlink transmission and also uplink transmission, the beam that may be used for downlink transmission, and the beam that may be used for uplink transmission. In response to the beam indication information being the joint beam indication information, the second field portion indicates the joint uplink and downlink beam indication, that is, used for indicating that the TCI state indicated by the first field portion corresponds to the beam that may be used for downlink transmission and also uplink transmission.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In response to the network device transmitting the joint beam indication information, the T identifiers indicate the joint uplink and downlink beam indication, while the max (M, N) bits indicate the TCI state corresponding to the beam that may be used for downlink transmission and also uplink transmission.

In S5032, transmit, by at least one of the MAC CE or the DCI, separate beam indication information to the terminal in response to the uplink and downlink beam indication mode being separate uplink beam indication and/or separate downlink beam indication, where the separate beam indication information is used for indicating, configured for the terminal, a beam that may be used for uplink transmission and/or a beam that may be used for downlink transmission.

In this embodiment, in case that the uplink and downlink beam indication mode is the separate uplink beam indication and/or separate downlink beam indication, the network device transmits the separate beam indication information to the terminal, to be used for indicating the beam that may be used for uplink transmission and/or the beam that may be used for downlink transmission.

In some examples, the separate beam indication information may be sent to the terminal by any of the following modes.

Mode I, at least one MAC CE is sent to the terminal. Where the at least one MAC CE includes a first MAC CE indicating one TCI state which corresponds to the beam that may be used for uplink transmission, and/or a second MAC CE indicating one TCI state which corresponds to the beam that may be used for downlink transmission.

In this embodiment, the network device may transmit the separate beam indication information through at least one MAC CE, where one MAC CE may be used for indicating (for example, activating) one TCI state to correspond to the beam that may be used for uplink transmission, and/or another MAC CE may be used for indicating (for example, activating) one TCI state to correspond to the beam that may be used for downlink transmission.

Mode II, at least one MAC CE and the DCI are sent to the terminal. Where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In this embodiment, the network device may transmit the separate beam indication information through the MAC CE and the DCI. The MAC CE indicates (for example, activates) a plurality of TCI states; and a first indication field of the DCI includes a first field portion indicating one TCI state, corresponding to the beam that may be used for downlink transmission, and/or one TCI state, corresponding to the beam that may be used for uplink transmission, in the plurality of TCI states. For example, the DCI includes the TCI field, which includes a plurality of bits for indicating one TCI state, the corresponding beam of which may be used for downlink transmission, and/or one TCI state, the corresponding beam of which may be used for uplink transmission.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In this embodiment, the network device may transmit the separate beam indication information through the MAC CE and the DCI. In some examples, the MAC CE indicates (for example, activates) a plurality of TCI states corresponding to the beam that may be used for uplink transmission and a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the plurality of TCI states activated by the MAC CE may include the TCI state corresponding to the beam that may be used for uplink transmission and the TCI state corresponding to the beam that may be used for downlink transmission. In case that the MAC AC activates the plurality of such TCI states, the DCI is used to select the corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. For example, the DCI may reuse the existing DCI format 1_1 and DCI format 1_2, for example, the TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. It should be noted that the TCI field of the DCI is not limited to the above description. For example, in some embodiments, the first M bits indicate the uplink beam, while the last N bits indicate the downlink beam.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

In this embodiment, the network device may transmit the separate beam indication information through the MAC CE and the DCI. In some examples, the MAC CE includes a MAC CE indicating (for example, activating) a plurality of TCI states corresponding to the beam that may be used for uplink transmission, and a MAC CE indicating (for example, activating) a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the MAC CE may identify whether the activated TCI states correspond to the beam that may be used for downlink transmission or the beam that may be used for uplink transmission. For example, the plurality of TCI states corresponding to the beam that may be used for downlink transmission may be activated by one MAC CE; and the plurality of TCI states corresponding to the beam that may be used for uplink transmission may be activated by another MAC CE. Then, the DCI is used to select a corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. The existing DCI format 1_1 and DCI format 1_2 may be reused. The TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by the predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. However, for the DCI used for the separate uplink beam indication, values of the corresponding last N bits may be used. It should be noted that the TCI field of the DCI is not limited to the above description. For example, in some embodiments, the first M bits indicate the uplink beam, while the last N bits indicate the downlink beam.

Mode III, the DCI is sent to the terminal, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In this embodiment, the network device may transmit the separate beam indication information through the DCI. In a case that there is a need for a beam indication, it is possible to first determine whether a currently activated TCI state (for example, the TCI state activated by the previously sent MAC CE) is available. In a case that there is a currently available activated TCI state, the network device may only transmit the DCI to the terminal, so as to indicate the beam. The first indication field of the DCI includes the first field portion indicating one TCI state, corresponding to the beam that may be used for uplink transmission, and/or one TCI state, corresponding to the beam that may be used for downlink transmission, in the plurality of activated TCI states. where a specific example of the DCI may refer to the above description.

In some embodiments, the first indication field, sent to the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In this embodiment, in a case that the network device transmits the beam indication information through the MAC CE and the DCI, the first indication field of the DCI may include the first field portion and the second field portion, where the second field portion is used as an identifier for identifying that the TCI state indicated by the first field portion corresponds to which one of the beam that may be used for downlink transmission and also uplink transmission, the beam that may be used for downlink transmission, and the beam that may be used for uplink transmission. In response to the beam indication information being the separate beam indication information, the second field portion indicates the separate downlink beam indication (that is, used for indicating that the TCI state indicated by the first field portion corresponds to the beam that may be used for downlink transmission), or the separate uplink beam indication (that is, used for indicating that the TCI state indicated by the first field portion corresponds to the beam that may be used for uplink transmission).

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In case that the network device transmits the separate beam indication information through the MAC CE and the DCI, the T identifiers indicate the separate uplink beam indication or the separate downlink beam indication. For the DCI used for the separate downlink beam indication, the T identifiers indicate the separate downlink beam indication, while the max (M, N) bits indicate the TCI state corresponding to the beam that may be used for downlink transmission. For the DCI used for the separate uplink beam indication, the T identifiers indicate the separate uplink beam indication, while the max (M, N) bits indicate the TCI state corresponding to the beam that may be used for uplink transmission.

In the beam indication method according to this embodiment, by including the identifier differentiating the serving cell and the adjacent cell in the TCI state configuration information of the RRC configuration signaling, the beam of the adjacent cell can be indicated for the terminal. Thus, in case that the beam performance of the adjacent cell is good, the adjacent cell can provide the service for the terminal, and the throughput of the terminal is increased. In addition, in response to whether the uplink and downlink beam indication mode being the joint uplink and downlink beam indication or the separate uplink beam indication and/or separate downlink beam indication, the joint beam indication information or the separate beam indication information is sent by at least one of the MAC CE or the DCI, so that the beam indication method that may be used in the case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

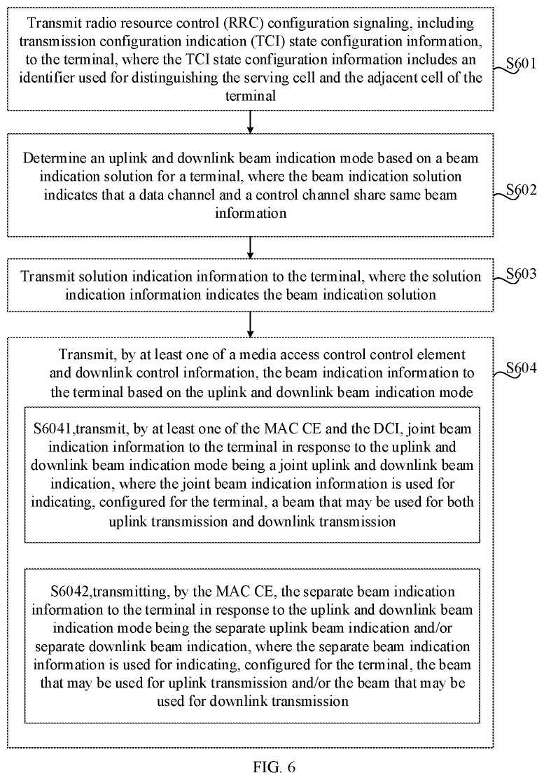

FIG. 6 is a flow chart of a beam indication method according to an embodiment of the present disclosure. In this embodiment, the method is executed by the network device. As shown in FIG. 6, the beam indication method includes the following steps S601-S604.

In S601, transmit radio resource control (RRC) configuration signaling, including transmission configuration indication (TCI) state configuration information, to the terminal, where the TCI state configuration information includes an identifier used for distinguishing a serving cell and an adjacent cell of the terminal.

In this embodiment, in order to distinguish the serving cell and the adjacent cell, the network device may introduce a new parameter upon using the RRC configuration signaling to configure the TCI state, and this parameter is used for distinguishing the serving cell and the adjacent cell.

In some embodiments, the identifier includes a physical cell identify (PCI) of the adjacent cell.

In S602, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the network device may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication. In some embodiments, the uplink and downlink beam indication mode may be notified to the terminal through the high layer signaling, that is, information identifying the uplink and downlink beam indication mode may be included in the high layer signaling. The high layer signaling may be signaling of other layers, for example, an RRC layer, a MAC layer or the like, except a physical layer.

In S603, transmit solution indication information to the terminal, where the solution indication information indicates the beam indication solution.

In this embodiment, the network device may transmit the solution indication information to the terminal, so as to notify the terminal of the beam indication solution for it, for example, through high layer signaling. The high layer signaling may be signaling of other layers, for example, an RRC layer, a MAC layer or the like, except a physical layer.

In some embodiments, the solution indication information further includes: information used for identifying a control resource set CORESET adapting to the beam indication solution.

The beam indication solution that the data channel and the control channel share the same beam information may not necessarily adapt to all physical downlink control channels. In this case, it may indicate that the beam indication solution adapts to which control resource set (CORESET) through the high layer signaling.

In S604, transmit, by at least one of a media access control control element (MAC CE) or downlink control information (DCI), the beam indication information to the terminal based on the uplink and downlink beam indication mode, where the beam indication information indicates a beam configured for the terminal.

In this embodiment, after determining the uplink and downlink beam indication mode, the network device may transmit the beam indication information to the terminal through the MAC CE and/or the DCI based on the uplink and downlink beam indication mode.

In some examples, the transmitting beam indication information to the terminal S604 may include any of the following steps S6041 and S6042.

S6041, transmitting, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission.

In this embodiment, in case that the uplink and downlink beam indication mode is the joint uplink and downlink beam indication, the network device transmits the joint beam indication information to the terminal, to be used for indicating the beam that may be used for both uplink transmission and downlink transmission.

In some examples, the joint beam indication information may be sent to the terminal by any of the following modes.

Mode I, the MAC CE is sent to the terminal. Where the MAC CE indicates one TCI state which corresponds to the beam that may be used for both uplink transmission and downlink transmission.

Mode II, the MAC CE and the DCI are sent to the terminal, where the MAC CE indicates a plurality of TCI states, and a first indication field of the DCI includes a first field portion indicating one TCI state, corresponding to the beam that may be used for uplink transmission and also downlink transmission, in the plurality of TCI states.

Mode III, the DCI is sent to the terminal, where the first indication field of the DCI includes a first field portion indicating one TCI state, corresponding to the beam that may be used for both uplink transmission and downlink transmission, in the plurality of activated TCI states.

In some embodiments, the first indication field, sent to the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

In S6042, transmit, by the MAC CE, the separate beam indication information to the terminal in response to the uplink and downlink beam indication mode being the separate uplink beam indication and/or separate downlink beam indication, where the separate beam indication information is used for indicating, configured for the terminal, the beam that may be used for uplink transmission and/or the beam that may be used for downlink transmission

In this embodiment, in case that the uplink and downlink beam indication mode is the separate uplink beam indication and/or separate downlink beam indication, the network device transmits the separate beam indication information to the terminal, to be used for indicating the beam that may be used for uplink transmission and/or the beam that may be used for downlink transmission.

In some examples, the separate beam indication information may be sent to the terminal by any of the following modes.

Mode I, at least one MAC CE is sent to the terminal. Where the at least one MAC CE includes a first MAC CE indicating one TCI state which corresponds to the beam that may be used for uplink transmission, and/or a second MAC CE indicating one TCI state which corresponds to the beam that may be used for downlink transmission.

Mode II, at least one MAC CE and the DCI are sent to the terminal, where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

Mode III, the DCI is sent to the terminal, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the first indication field, sent to the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

The above steps S6041 and S6042 correspond to steps S5031 and S5032 shown in FIG. 5 respectively. Therefore, the specific contents of steps S6041 and S6042 may refer to the above description of steps S5031 and S5032, which will not be described any more.

In the beam indication method according to this embodiment, by including the identifier differentiating the serving cell and the adjacent cell in the TCI state configuration information of the RRC configuration signaling, the beam of the adjacent cell can be indicated for the terminal. Thus, in case that the beam performance of the adjacent cell is good, the adjacent cell can provide the service for the terminal, and the throughput of the terminal is increased. In addition, in response to whether the uplink and downlink beam indication mode being the joint uplink and downlink beam indication or the separate uplink beam indication and/or separate downlink beam indication, the joint beam indication information or the separate beam indication information is sent by at least the MAC CE, so that the beam indication method that may be used in the case that the data channel and the control channel share the common beam indication is provided.

It should be noted that the above steps S602-S604 are not necessarily executed sequentially. For example, S603 may further be executed before S602 or after S604.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

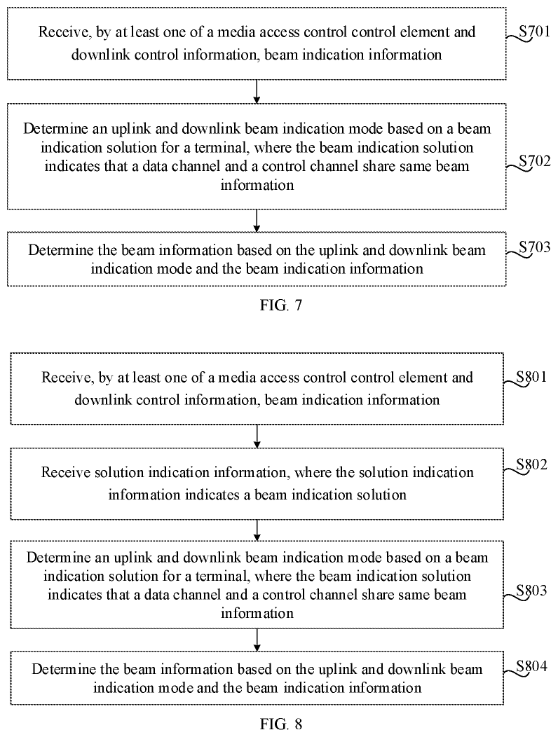

FIG. 7 is a flow chart of a beam determination method according to an embodiment of the present disclosure. In this embodiment, the method is executed by a terminal. As shown in FIG. 7, the beam determination method includes the following steps S701-S703.

In S701, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In S702, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S703, determine the beam information based on the uplink and downlink beam indication mode and the beam indication information.

In response to determining that the beam indication information is received, the beam information is determined according to the uplink and downlink beam indication mode and the beam indication information.

In the beam determination method according to this embodiment, the uplink and downlink beam indication mode is determined by receiving the beam indication information by the MAC CE and/or the DCI based on the beam indication solution indicating that the data channel and the control channel share the same beam information; and the beam information is determined according to the beam indication information and the uplink and downlink beam indication mode, so that the beam determination method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

FIG. 8 is a flow chart of a beam determination method according to an embodiment of the present disclosure. In this embodiment, the method is executed by a terminal. As shown in FIG. 8, the beam determination method includes the following steps S801-S804.

In S801, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In S802, receive solution indication information, where the solution indication information indicates a beam indication solution.

In this embodiment, the terminal may receive the solution indication information from the network device, and the solution indication information indicates its beam indication solution for the terminal, for example, the network device transmits the solution indication information to the terminal through high layer signaling. The high layer signaling may be signaling of other layers, for example, an RRC layer, a MAC layer or the like, except a physical layer.

In some embodiments, the solution indication information further includes: information used for identifying a control resource set CORESET adapting to the beam indication solution.

The beam indication solution that the data channel and the control channel share the same beam information may not necessarily adapt to all physical downlink control channels. In this case, the high layer signaling may indicate that the beam indication solution adapts to which control resource set (CORESET).

In S803, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S804, determine the beam information based on the uplink and downlink beam indication mode and the beam indication information.

In response to determining that the beam indication information is received, the beam information is determined according to the uplink and downlink beam indication mode and the beam indication information.

In the beam determination method according to this embodiment, the uplink and downlink beam indication mode is determined by receiving the beam indication information by at least one of the MAC CE or the DCI based on the beam indication solution indicating that the data channel and the control channel share the same beam information; and the beam information is determined according to the beam indication information and the uplink and downlink beam indication mode, so that the beam determination method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

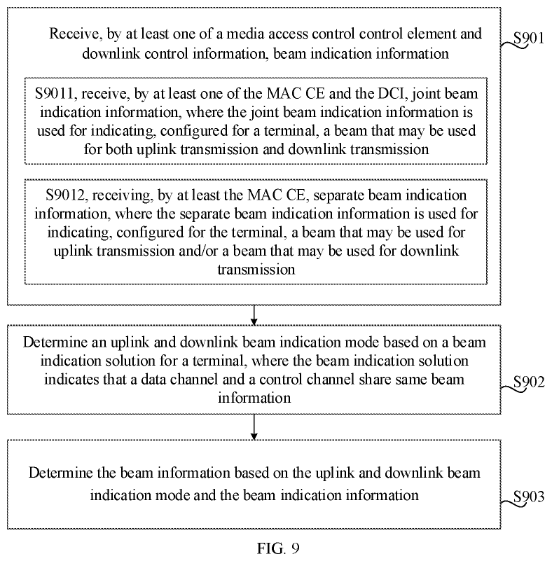

FIG. 9 is a flow chart of a beam determination method according to an embodiment of the present disclosure. In this embodiment, the method is executed by a terminal. As shown in FIG. 9, the beam determination method includes the following steps S901-S903.

In S901, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In some examples, the receiving beam indication information, step S901, may include any of the following steps S9011 and S9012.

In S9011, receive, by at least one of the MAC CE or the DCI, joint beam indication information, where the joint beam indication information is used for indicating, configured for the terminal, a beam that may be used for both uplink transmission and downlink transmission.

In this embodiment, the terminal may receive the joint beam indication information used for indicating the beam that may be used for both uplink transmission and downlink transmission from the network device.

In some examples, the joint beam indication information may be received by any of the following modes.

Mode I, the MAC CE is received. Where the MAC CE indicates one TCI state which corresponds to the beam that may be used for both uplink transmission and downlink transmission. In general, each TCI state may correspondingly indicate a beam used for uplink and/or downlink transmission. Here, the MAC CE indicating the TCI state may represent that the MAC CE indicates the TCI state for the terminal to activate the TCI state.

In this embodiment, the terminal may receive the joint beam indication information through the MAC CE, where the MAC CE indicates (for example, activates) one TCI state, the corresponding beam of which may be used for uplink transmission and also downlink transmission; and downlink transmission and uplink transmission use the same beam.

Mode II, the MAC CE and the DCI are received, where the MAC CE indicates a plurality of TCI states, and a first indication field of the DCI includes a first field portion indicating one TCI state, corresponding to the beam that may be used for both uplink transmission and downlink transmission, in the plurality of TCI states.

In this embodiment, the terminal may receive the joint beam indication information through the MAC CE and the DCI, where the MAC CE indicates (for example, activates) a plurality of TCI states, and a first indication field of the DCI includes a first field portion indicating one TCI state, corresponding to the beam that may be used for downlink transmission and also uplink transmission, in the plurality of TCI states. For example, the DCI includes a TCI field, which includes a plurality of bits for indicating one TCI state. The corresponding beam of the TCI state may be used for downlink transmission and also uplink transmission. Therefore, in a case that the MAC CE activates a plurality of TCI states, one TCI state may be selected from the plurality of activated TCI states using the DCI, so as to indicate the beam that may be used for downlink transmission and also uplink transmission. An existing DCI format 1_1 and DCI format 1_2 may be reused. In one example, the TCI field in the DCI is fixed to include M bits for indicating one TCI state corresponding to the beam that may be used for downlink transmission and also uplink transmission. In another example, the TCI field in the DCI is fixed to include M+N bits, including M bits for indicating the TCI state corresponding to the beam that may be used for downlink transmission, and N bits for indicating the TCI state corresponding to the beam that may be used for uplink transmission. The M bits and the N bits may be distinguished by predetermined locations of the network device and the terminal. It should be noted that the TCI field of the DCI is not limited to the above description, for example, in some embodiments, the first M bits indicate an uplink beam, and the last N bits indicate a downlink beam, where the M bits and the N bits may indicate the same TCI state, so as to indicate the beam that may be used for downlink transmission and also uplink transmission.

Mode III, the DCI is received, where the first indication field of the DCI includes a first field portion indicating one TCI state, corresponding to the beam that may be used for both uplink transmission and downlink transmission, in the plurality of activated TCI states.

In this embodiment, the terminal may receive the joint beam indication information through the DCI. In a case that there is a need for a beam indication, it is possible to first determine whether a currently activated TCI state (for example, the TCI state activated by the previously sent MAC CE) is available. In a case that there is a currently available activated TCI state, the terminal may only receive the DCI from the network device, so as to determine the beam information according to the DCI. The first indication field of the DCI includes the first field portion indicating one TCI state, corresponding to the beam that may be used for downlink transmission and also uplink transmission, in the plurality of activated TCI states, where a specific example of the DCI may refer to the above description.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In this embodiment, the first indication field, received by the terminal, of the DCI may include the first field portion and the second field portion, where the second field portion is used as an identifier for identifying that the TCI state indicated by the first field portion corresponds to which one of the beam that may be used for downlink transmission and also uplink transmission, the beam that may be used for downlink transmission, and the beam that may be used for uplink transmission. In response to the beam indication information being the joint beam indication information, the second field portion indicates that the TCI state indicated by the first field portion corresponds to the beam that may be used for downlink transmission and also uplink transmission.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In response to the network device transmitting the joint beam indication information through the MAC CE and the DCI, the T identifiers indicate the joint uplink and downlink beam indication, while the max (M, N) bits indicate the TCI state corresponding to the beam that may be used for downlink transmission and also uplink transmission.

In S9012, receive, by at least the MAC CE, separate beam indication information, where the separate beam indication information is used for indicating, configured for the terminal, a beam that may be used for uplink transmission and/or a beam that may be used for downlink transmission.

In this embodiment, the terminal may receive the separate beam indication information used for indicating the beam that may be used for uplink transmission, and/or the beam that may be used for downlink transmission from the network device.

In some examples, the separate beam indication information may be received by any of the following modes.

Mode I, at least one MAC CE is received. Where the at least one MAC CE includes a first MAC CE indicating one TCI state which corresponds to the beam that may be used for uplink transmission, and/or a second MAC CE indicating one TCI state which corresponds to the beam that may be used for downlink transmission.

In this embodiment, the terminal may receive the separate beam indication information through at least one MAC CE, where one MAC CE may be used for indicating (for example, activating) one TCI state to correspond to the beam that may be used for uplink transmission, and/or another MAC CE may be used for indicating (for example, activating) one TCI state to correspond to the beam that may be used for downlink transmission.

Mode II, at least one MAC CE and the DCI are received, where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In this embodiment, the terminal may receive the separate beam indication information through at least one MAC CE and the DCI, where the at least one MAC CE indicates (for example, activates) a plurality of TCI states, and a first indication field of the DCI includes a first field portion indicating one TCI state, corresponding to the beam that may be used for downlink transmission, and/or one TCI state, corresponding to the beam that may be used for uplink transmission, in the plurality of TCI states. For example, the DCI includes the TCI field, which includes a plurality of bits for indicating one TCI state, the corresponding beam of which may be used for downlink transmission, and/or one TCI state, the corresponding beam of which may be used for uplink transmission.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In this embodiment, the terminal may receive the separate beam indication information through the MAC CE and the DCI. In some examples, the MAC CE indicates a plurality of TCI states corresponding to the beam that may be used for uplink transmission and a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the plurality of TCI states activated by the MAC CE may include the TCI state corresponding to the beam that may be used for uplink transmission and the TCI state corresponding to the beam that may be used for downlink transmission. In case that the MAC AC activates the plurality of such TCI states, the DCI is used to select the corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. For example, the DCI may reuse the existing DCI format 1_1 and DCI format 1_2, for example, the TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. It should be noted that the TCI field of the DCI is not limited to the above description. For example, in some embodiments, the first M bits indicate the uplink beam, while the last N bits indicate the downlink beam.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

In this embodiment, the terminal may receive the separate beam indication information through the MAC CE and the DCI. In some examples, the MAC CE includes a MAC CE indicating a plurality of TCI states corresponding to the beam that may be used for uplink transmission, and a MAC CE indicating a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the MAC CE may identify whether the activated TCI states correspond to the beam that may be used for downlink transmission or the beam that may be used for uplink transmission. For example, the plurality of TCI states corresponding to the beam that may be used for downlink transmission may be activated by one MAC CE; and the plurality of TCI states corresponding to the beam that may be used for uplink transmission may be activated by another MAC CE. Then, the DCI is used to select a corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. The existing DCI format 1_1 and DCI format 1_2 may be reused. The TCI field in the DCI is fixed to include M+N bits, including the M bits for indicating the beam that may be used for downlink transmission, and the N bits for indicating the beam that may be used for uplink transmission. The M bits and the N bits may be distinguished by the predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. However, for the DCI used for the separate uplink beam indication, values of the corresponding last N bits may be used. It should be noted that the TCI field of the DCI is not limited to the above description. For example, in some embodiments, the first M bits indicate the uplink beam, while the last N bits indicate the downlink beam.

Mode III, the DCI is received, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In this embodiment, the terminal may receive the separate beam indication information through the DCI. In a case that there is a need for a beam indication, it is possible to first determine whether a currently activated TCI state (for example, the TCI state activated by the previously sent MAC CE) is available. In a case that there is a currently available activated TCI state, the terminal may only receive the DCI from the network device, so as to determine the beam information according to the DCI. The first indication field of the DCI includes the first field portion indicating one TCI state, corresponding to the beam that may be used for uplink transmission, and/or one TCI state, corresponding to the beam that may be used for downlink transmission, in the plurality of activated TCI states. where a specific example of the DCI may refer to the above description.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In this embodiment, the first indication field of the DCI may include the first field portion and the second field portion, where the second field portion is used as an identifier for identifying that the TCI state indicated by the first field portion corresponds to which one of the beams that may be used for downlink and also uplink transmission, the beam that may be used for downlink transmission, and the beam that may be used for uplink transmission. In response to the beam indication information being the separate beam indication information, the second field portion indicates that the TCI state indicated by the first field portion corresponds to the beam that may be used for downlink transmission or the beam that may be used for uplink transmission.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In case that the network device transmits the separate beam indication information through the MAC CE and the DCI, the T identifiers indicate the separate uplink beam indication or the separate downlink beam indication. For the DCI used for the separate downlink beam indication, the T identifiers indicate the separate downlink beam indication, while the max (M, N) bits indicate the TCI state corresponding to the beam that may be used for downlink transmission. For the DCI used for the separate uplink beam indication, the T identifiers indicate the separate uplink beam indication, while the max (M, N) bits indicate the TCI state corresponding to the beam that may be used for uplink transmission.

Then, in S902, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information. In an example, in case that the terminal only receives the MAC CE indicating one TCI state, the terminal may determine the uplink and downlink beam indication mode as the joint uplink and downlink beam indication. In another example, in a case that the terminal receives the MAC CE and the DCI, and the TCI field in the DCI is fixed to include the M+N bits, in response to determining that the M bits and the N bits may indicate the same TCI state, the terminal may determine the uplink and downlink beam indication mode as the joint uplink and downlink beam indication; and in response to determining that the M bits and the N bits may indicate different TCI states, the terminal may determine the uplink and downlink beam indication mode as the separate uplink beam indication and/or separate downlink beam indication. In another example, in a case that the terminal receives the MAC CE and the DCI, and the TCI field in the DCI is fixed to include the T+max(M, N) bits, the terminal may determine the uplink and downlink beam indication mode in response to the T bits indicating the joint uplink and downlink beam indication, or the separate uplink beam indication or the separate downlink beam indication.

In S903, determine the beam information based on the uplink and downlink beam indication mode and the beam indication information.

In response to determining that the beam indication information is received, the beam information is determined according to the uplink and downlink beam indication mode and the beam indication information.

In the beam determination method according to this embodiment, the uplink and downlink beam indication mode is determined by receiving the beam indication information by at least one of the MAC CE or the DCI based on the beam indication solution indicating that the data channel and the control channel share the same beam information; and the beam information is determined according to the beam indication information and the uplink and downlink beam indication mode, so that the beam determination method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

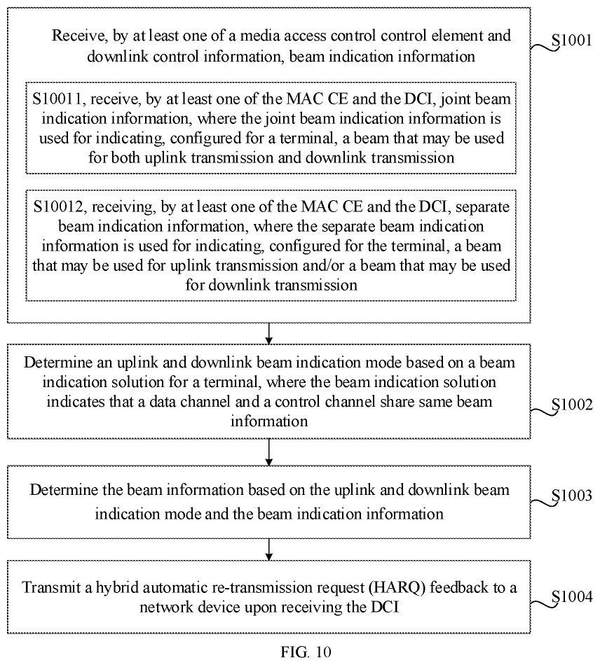

FIG. 10 is a flow chart of a beam determination method according to an embodiment of the present disclosure. In this embodiment, the method is executed by a terminal. As shown in FIG. 10, the beam determination method includes the following steps S1001-S1004.

In S1001, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In some examples, the receiving beam indication information in S1001 may include any of the following steps S10011 and S10012.

In S10011, receive, by at least one of the MAC CE or the DCI, joint beam indication information, where the joint beam indication information is used for indicating, configured for the terminal, a beam that may be used for both uplink transmission and downlink transmission.

In this embodiment, the terminal may receive the joint beam indication information used for indicating the beam that may be used for both uplink transmission and downlink transmission from the network device.

In some examples, the joint beam indication information may be received by any of the following modes.

Mode I, the MAC CE is received. Where the MAC CE indicates one TCI state which corresponds to the beam that may be used for both uplink transmission and downlink transmission.

Mode II, the MAC CE and the DCI are received, where the MAC CE indicates a plurality of TCI states, and a first indication field of the DCI includes a first field portion indicating one TCI state, corresponding to the beam that may be used for both uplink transmission and downlink transmission, in the plurality of TCI states.

Mode III, the DCI is received, where the first indication field of the DCI includes a first field portion indicating one TCI state, corresponding to the beam that may be used for both uplink transmission and downlink transmission, in the plurality of activated TCI states.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

In S10012, receive, by at least one of the MAC CE or the DCI, separate beam indication information, where the separate beam indication information is used for indicating, configured for the terminal, a beam that may be used for uplink transmission and/or a beam that may be used for downlink transmission.

In this embodiment, the terminal may receive the separate beam indication information used for indicating the beam that may be used for uplink transmission, and/or the beam that may be used for downlink transmission from the network device.

In some examples, the separate beam indication information may be received by any of the following modes.

Mode I, at least one MAC CE is received, where the at least one MAC CE includes a first MAC CE indicating one TCI state which corresponds to the beam that may be used for uplink transmission, and/or a second MAC CE indicating one TCI state which corresponds to the beam that may be used for downlink transmission.

Mode II, at least one MAC CE and the DCI are received, where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

Mode III, the DCI is received, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

The above steps S10011 and S10012 correspond to steps S9011 and S9012 shown in FIG. 9 respectively. Therefore, the specific contents of steps S10011 and S10012 may refer to the above description of steps S9011 and S9012, which will not be described any more.

Then, in S1002, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S1003, determine the beam information based on the uplink and downlink beam indication mode and the beam indication information.

In response to determining that the beam indication information is received, the beam information is determined according to the uplink and downlink beam indication mode and the beam indication information.

In S1004, transmit a hybrid automatic re-transmission request (HARQ) feedback to a network device upon receiving the DCI.

In response to determining that the beam indication information including the DCI is received, the terminal may transmit a corresponding hybrid automatic re-transmission request (HARQ) feedback to the network device, so as to notify the network device that the DCI has been received.

It should be noted that an execution order of the above steps is not limited to the above description.

In the beam determination method according to this embodiment, the uplink and downlink beam indication mode is determined by receiving the beam indication information by at least one of the MAC CE or the DCI based on the beam indication solution indicating that the data channel and the control channel share the same beam information. The beam information is determined according to the beam indication information and the uplink and downlink beam indication mode. And an HARQ message is fed back after the DCI is received, so that the network device can know whether the terminal receives the DCI.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

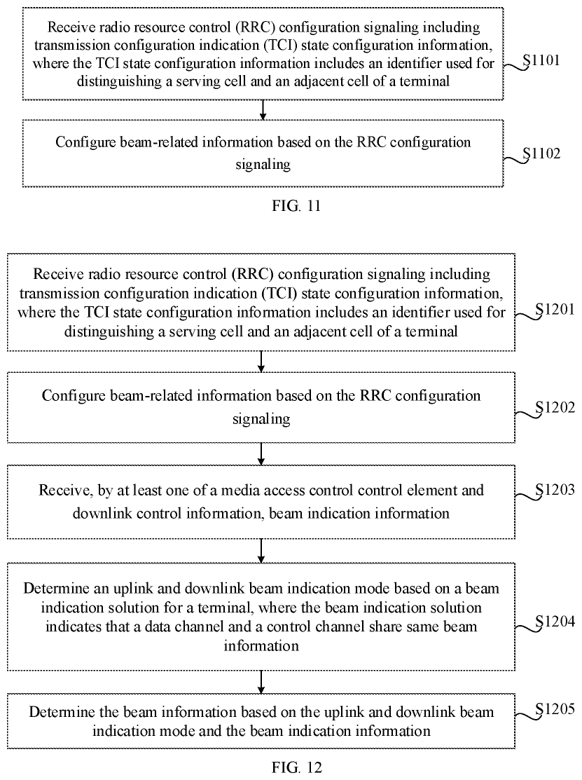

FIG. 11 is a flow chart of a beam determination method according to an embodiment of the present disclosure. In this embodiment, the method is executed by a terminal. As shown in FIG. 11, the beam determination method includes the following steps S1101 and S1102.

In S1101, receive radio resource control (RRC) configuration signaling including transmission configuration indication (TCI) state configuration information, where the TCI state configuration information includes an identifier used for distinguishing a serving cell and an adjacent cell of a terminal.

In this embodiment, in order to distinguish the serving cell and the adjacent cell, the network device may introduce a new parameter upon using the RRC configuration signaling to configure the TCI state, and this new parameter is used for distinguishing the serving cell and the adjacent cell. For example, for a case where the data channel and the control channel share the common beam indication, neighborcellindex is introduced to distinguish the serving cell and the adjacent cell in the case that the RRC configuration signaling is used to configure an uplink TCI state and a downlink TCI state. For a case where the data channel and the control channel use dedicated beam indications, neighborcellindex is introduced to distinguish the serving cell and the adjacent cell in a case that the RRC configuration signaling is used to configure the TCI state and a spatial relation. Thus, the terminal may receive the RRC configuration signaling, in which the TCI state configuration information includes the identifier used for distinguishing the serving cell and the adjacent cell of the terminal.

In some embodiments, the identifier includes a physical cell identify (PCI) of the adjacent cell.

In S1102, configure the beam-related information based on the RRC configuration signaling.

In response to determining that the terminal has received the RRC configuration signaling, in which the TCI state configuration information includes the identifier used for distinguishing the serving cell and the adjacent cell of the terminal, the beam-related information is configured based on the RRC configuration signaling.

In the beam determination method according to this embodiment, by configuring the beam-related information based on the RRC configuration signaling, in which the TCI state configuration information includes the identifier used for distinguishing the serving cell and the adjacent cell, the beam of the adjacent cell can be indicated for the terminal. Thus, in case that the beam performance of the adjacent cell is good, the adjacent cell can provide a service for the terminal, and a throughput of the terminal is increased.

FIG. 12 is a flow chart of a beam determination method according to an embodiment of the present disclosure. In this embodiment, the method is executed by a terminal. As shown in FIG. 12, the beam determination method includes the following steps S1201-S1205.

In S1201, receive radio resource control (RRC) configuration signaling including transmission configuration indication (TCI) state configuration information, where the TCI state configuration information includes an identifier used for distinguishing a serving cell and an adjacent cell of a terminal.

In this embodiment, in order to distinguish the serving cell and the adjacent cell, the network device may introduce a new parameter upon using the RRC configuration signaling to configure the TCI state, and this new parameter is used for distinguishing the serving cell and the adjacent cell. Thus, the terminal may receive the RRC configuration signaling, in which the TCI state configuration information includes the identifier used for distinguishing the serving cell and the adjacent cell of the terminal.

In some embodiments, the identifier includes a physical cell identify (PCI) of the adjacent cell.

In S1202, configure beam-related information based on the RRC configuration signaling.

In response to determining that the terminal has received the RRC configuration signaling, in which the TCI state configuration information includes the identifier used for distinguishing the serving cell and the adjacent cell of the terminal, the beam-related information is configured based on the RRC configuration signaling.

In S1203, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In S1204, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. The separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S1205, determine the beam information based on the uplink and downlink beam indication mode and the beam indication information.

In response to determining that the beam indication information is received, the beam information is determined according to the uplink and downlink beam indication mode and the beam indication information.

It should be noted that an execution order of the above steps is not limited to the that in this embodiment.

In the beam determination method according to this embodiment, by configuring the beam-related information based on the RRC configuration signaling, in which the TCI state configuration information includes the identifier used for distinguishing the serving cell and the adjacent cell, the beam of the adjacent cell can be indicated for the terminal. Thus, in case that the beam performance of the adjacent cell is good, the adjacent cell can provide a service for the terminal, and a throughput of the terminal is increased. In addition, the uplink and downlink beam indication mode is determined by receiving the beam indication information by at least one of the MAC CE or the DCI based on the beam indication solution indicating that the data channel and the control channel share the same beam information. The beam information is determined according to the beam indication information and the uplink and downlink beam indication mode, so that the beam determination method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

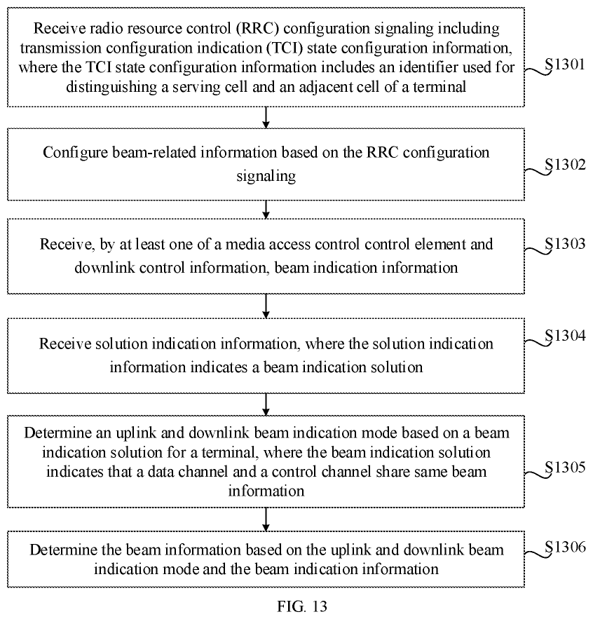

FIG. 13 is a flow chart of a beam determination method according to an embodiment of the present disclosure. In this embodiment, the method is executed by a terminal. As shown in FIG. 13, the beam determination method includes the following steps S1301-S1306.

In S1301, receive radio resource control (RRC) configuration signaling including transmission configuration indication (TCI) state configuration information, where the TCI state configuration information includes an identifier used for distinguishing a serving cell and an adjacent cell of a terminal.

In this embodiment, in order to distinguish the serving cell and the adjacent cell, the network device may introduce a new parameter upon using the RRC configuration signaling to configure the TCI state, and this parameter is used for distinguishing the serving cell and the adjacent cell. Thus, the terminal may receive the RRC configuration signaling, in which the TCI state configuration information includes the identifier used for distinguishing the serving cell and the adjacent cell of the terminal.

In some embodiments, the identifier includes a physical cell identify (PCI) of the adjacent cell.

In S1302, configure beam-related information based on the RRC configuration signaling.

In response to determining that the terminal has received the RRC configuration signaling, in which the TCI state configuration information includes the identifier used for distinguishing the serving cell and the adjacent cell of the terminal, the beam-related information is configured based on the RRC configuration signaling.

In S1303, receive, at least by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In S1304, receive solution indication information, where the solution indication information indicates a beam indication solution.

In this embodiment, the terminal may receive the solution indication information from the network device, and the solution indication information indicates its beam indication solution for the terminal. For example, the network device transmits the solution indication information to the terminal through high layer signaling. The high layer signaling may be signaling of other layers, for example, an RRC layer, a MAC layer or the like, except a physical layer.

In some embodiments, the solution indication information further includes: information used for identifying a control resource set CORESET adapting to the beam indication solution.

The beam indication solution that the data channel and the control channel share the same beam information may not necessarily adapt to all physical downlink control channels. In this case, it may indicate that the beam indication solution adapts to which control resource set (CORESET) through the high layer signaling.

In S1305, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. The separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S1306, determine the beam information based on the uplink and downlink beam indication mode and the beam indication information.

In response to determining that the beam indication information is received, the beam information is determined according to the uplink and downlink beam indication mode and the beam indication information.

It should be noted that an execution order of the above steps is not limited to the that in this embodiment.

In the beam determination method according to this embodiment, by configuring the beam-related information based on the RRC configuration signaling, in which the TCI state configuration information includes the identifier used for distinguishing the serving cell and the adjacent cell, the beam of the adjacent cell can be indicated for the terminal. Thus, in case that the beam performance of the adjacent cell is good, the adjacent cell can provide a service for the terminal, and a throughput of the terminal is increased. In addition, the uplink and downlink beam indication mode is determined by receiving the beam indication information by at least one of the MAC CE or the DCI based on the beam indication solution indicating that the data channel and the control channel share the same beam information. The beam information is determined according to the beam indication information and the uplink and downlink beam indication mode, so that the beam determination method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

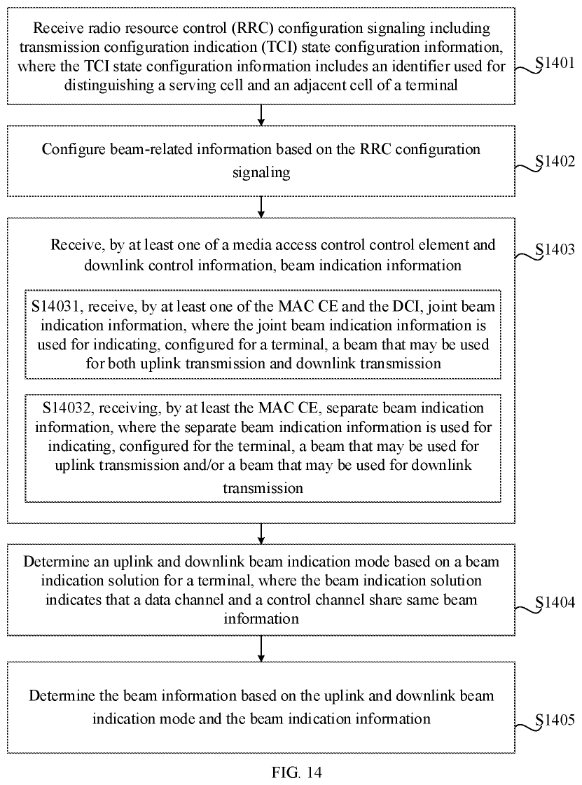

FIG. 14 is a flow chart of a beam determination method according to an embodiment of the present disclosure. In this embodiment, the method is executed by a terminal. As shown in FIG. 14, the beam determination method includes the following steps S1401-S1405.

In S1401, receive radio resource control (RRC) configuration signaling including transmission configuration indication (TCI) state configuration information, where the TCI state configuration information includes an identifier used for distinguishing a serving cell and an adjacent cell of a terminal.

In this embodiment, in order to distinguish the serving cell and the adjacent cell, the network device may introduce a new parameter upon using the RRC configuration signaling to configure the TCI state, and this new parameter is used for distinguishing the serving cell and the adjacent cell. Thus, the terminal may receive the RRC configuration signaling, in which the TCI state configuration information includes the identifier used for distinguishing the serving cell and the adjacent cell of the terminal.

In some embodiments, the identifier includes a physical cell identify (PCI) of the adjacent cell.

In S1402, configure beam-related information based on the RRC configuration signaling.

In response to determining that the terminal has received the RRC configuration signaling, in which the TCI state configuration information includes the identifier used for distinguishing the serving cell and the adjacent cell of the terminal, the beam-related information is configured based on the RRC configuration signaling.

In S1403, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In some examples, the receiving beam indication information in S1403 may include any of the following steps S14031 and S14032.

In S14031, receive, by at least one of the MAC CE or the DCI, joint beam indication information, where the joint beam indication information is used for indicating, configured for the terminal, a beam that may be used for both uplink transmission and downlink transmission.

In this embodiment, the terminal may receive the joint beam indication information used for indicating the beam that may be used for both uplink transmission and downlink transmission from the network device.

In some examples, the joint beam indication information may be received by any of the following modes.

Mode I, the MAC CE is received. Where the MAC CE indicates one TCI state which corresponds to the beam that may be used for both uplink transmission and downlink transmission. In general, each TCI state may correspondingly indicate a beam used for uplink and/or downlink transmission. Here, the MAC CE indicating the TCI state may represent that the MAC CE indicates the TCI state for the terminal to activate the TCI state.

In this embodiment, the terminal may receive the joint beam indication information through the MAC CE, where the MAC CE indicates (for example, activates) one TCI state, the corresponding beam of which may be used for uplink transmission and also downlink transmission; and downlink transmission and uplink transmission use the same beam.

Mode II, the MAC CE and the DCI are received, where the MAC CE indicates a plurality of TCI states, and a first indication field of the DCI includes a first field portion indicating one TCI state, corresponding to the beam that may be used for both uplink transmission and downlink transmission, in the plurality of TCI states.

In this embodiment, the terminal may receive the joint beam indication information through the MAC CE and the DCI, where the MAC CE indicates (for example, activates) a plurality of TCI states, and a first indication field of the DCI includes a first field portion indicating one TCI state, corresponding to the beam that may be used for downlink transmission and also uplink transmission, in the plurality of TCI states. For example, the DCI includes a TCI field, which includes a plurality of bits for indicating one TCI state. The corresponding beam of the TCI state may be used for downlink transmission and also uplink transmission. Therefore, in a case that the MAC CE activates a plurality of TCI states, one TCI state may be selected from the plurality of activated TCI states using the DCI, so as to indicate the beam that may be used for downlink transmission and also uplink transmission. An existing DCI format 1_1 and DCI format 1_2 may be reused. In one example, the TCI field in the DCI is fixed to include M bits for indicating one TCI state corresponding to the beam that may be used for downlink transmission and also uplink transmission. In another example, the TCI field in the DCI is fixed to include M+N bits, including M bits for indicating the TCI state corresponding to the beam that may be used for downlink transmission, and N bits for indicating the TCI state corresponding to the beam that may be used for uplink transmission. The M bits and the N bits may be distinguished by predetermined locations of the network device and the terminal. It should be noted that the TCI field of the DCI is not limited to the above description, for example, in some embodiments, the first M bits indicate an uplink beam, and the last N bits indicate a downlink beam, where the M bits and the N bits may indicate the same TCI state, so as to indicate the beam that may be used for downlink transmission and also uplink transmission.

Mode III, the DCI is received, where the first indication field of the DCI includes a first field portion indicating one TCI state, corresponding to the beam that may be used for both uplink transmission and downlink transmission, in the plurality of activated TCI states.

In this embodiment, the terminal may receive the joint beam indication information through the DCI. In case that there is a need for a beam indication, it is possible to first determine whether a currently activated TCI state (for example, the TCI state activated by the previously sent MAC CE) is available. In case that there is a currently available activated TCI state, the terminal may receive the DCI from the network device, so as to determine the beam information according to the DCI. The first indication field of the DCI includes the first field portion indicating one TCI state, corresponding to the beam that may be used for downlink transmission and also uplink transmission, in the plurality of activated TCI states, where a specific example of the DCI may refer to the above description.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In this embodiment, the first indication field, received by the terminal, of the DCI may include the first field portion and the second field portion, where the second field portion is used as an identifier for identifying that the TCI state indicated by the first field portion corresponds to which one of the beam that may be used for downlink transmission and also uplink transmission, the beam that may be used for downlink transmission, and the beam that may be used for uplink transmission. In response to the beam indication information being the joint beam indication information, the second field portion indicates that the TCI state indicated by the first field portion corresponds to the beam that may be used for downlink transmission and also uplink transmission.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In response to the network device transmitting the joint beam indication information through the MAC CE and the DCI, the T identifiers indicate the joint uplink and downlink beam indication, while max (M, N) bits indicate the TCI state corresponding to the beam that may be used for downlink transmission and also uplink transmission.

In S14032, receive, by at least the MAC CE, separate beam indication information, where the separate beam indication information is used for indicating, configured for the terminal, a beam that may be used for uplink transmission and/or a beam that may be used for downlink transmission.

In this embodiment, the terminal may receive the separate beam indication information used for indicating the beam that may be used for uplink transmission, and/or the beam that may be used for downlink transmission from the network device.

In some examples, the separate beam indication information may be received by any of the following modes.

Mode I, at least one MAC CE is received. Where the at least one MAC CE includes a first MAC CE indicating one TCI state which corresponds to the beam that may be used for uplink transmission, and/or a second MAC CE indicating one TCI state which corresponds to the beam that may be used for downlink transmission.

In this embodiment, the terminal may receive the separate beam indication information through at least one MAC CE, where one MAC CE may be used for indicating (for example, activating) one TCI state to correspond to the beam that may be used for uplink transmission, and/or another MAC CE may be used for indicating (for example, activating) one TCI state to correspond to the beam that may be used for downlink transmission.

Mode II, at least one MAC CE and the DCI are received, where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In this embodiment, the terminal may receive the separate beam indication information through at least one MAC CE and the DCI, where the at least one MAC CE indicates (for example, activates) a plurality of TCI states, and a first indication field of the DCI includes a first field portion indicating one TCI state, corresponding to the beam that may be used for downlink transmission, and/or one TCI state, corresponding to the beam that may be used for uplink transmission, in the plurality of TCI states. For example, the DCI includes the TCI field, which includes a plurality of bits for indicating one TCI state, the corresponding beam of which may be used for downlink transmission, and/or one TCI state, the corresponding beam of which may be used for uplink transmission.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In this embodiment, the terminal may receive the separate beam indication information through the MAC CE and the DCI. In some examples, the MAC CE indicates a plurality of TCI states corresponding to the beam that may be used for uplink transmission and a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the plurality of TCI states activated by the MAC CE may include the TCI state corresponding to the beam that may be used for uplink transmission and the TCI state corresponding to the beam that may be used for downlink transmission. In case that the MAC AC activates the plurality of such TCI states, the DCI is used to select the corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. For example, the DCI may reuse the existing DCI format 1_1 and DCI format 1_2, for example, the TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. It should be noted that the TCI field of the DCI is not limited to the above description. For example, in some embodiments, the first M bits indicate the uplink beam, while the last N bits indicate the downlink beam.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

In this embodiment, the terminal may receive the separate beam indication information through the MAC CE and the DCI. In some examples, the MAC CE includes a MAC CE indicating a plurality of TCI states corresponding to the beam that may be used for uplink transmission, and a MAC CE indicating a plurality of TCI state corresponding to the beam that may be used for downlink transmission; and a first indication field of the DCI includes a first field portion indicating one TCI state, corresponding to the beam that may be used for downlink transmission, and/or one TCI state, corresponding to the beam that may be used for uplink transmission, in the plurality of TCI states. In this case, the MAC CE may identify whether the activated TCI states correspond to the beam that may be used for downlink transmission or the beam that may be used for uplink transmission. For example, the plurality of TCI states corresponding to the beam that may be used for downlink transmission may be activated by one MAC CE; and the plurality of TCI states corresponding to the beam that may be used for uplink transmission may be activated by another MAC CE. Then, the DCI is used to select a corresponding TCI state from the plurality of activated TCI states to indicate the beam that may be used for downlink transmission and/or select the corresponding TCI state from the plurality of activated TCI states to indicate the beam that may be used for uplink transmission. In some examples, for example, the TCI state corresponding to the beam that may be used for downlink transmission is selected according to the plurality of bits for indicating the beam that may be used for downlink transmission in the TCI field of the DCI, and the TCI state corresponding to the beam that may be used for uplink transmission is selected according to the plurality of bits for indicating the beam that may be used for uplink transmission in the TCI field. The existing DCI format 1_1 and DCI format 1_2 may be reused. The TCI field in the DCI is fixed to include M+N bits, including the M bits for indicating the TCI state corresponding to the beam that may be used for downlink transmission, and the N bits for indicating the TCI state corresponding to the beam that may be used for uplink transmission. The M bits and the N bits may be distinguished by the predetermined locations of the network device and the terminal. For the DCI used for the separate downlink beam indication and the separate uplink beam indication, the M+N bits are used, where the M bits and the N bits may indicate different TCI states, so as to indicate the beam that may be used for downlink transmission and the beam that may be used for uplink transmission, respectively. For the DCI used for the separate downlink beam indication, the corresponding M bits may be used; while for the DCI used for the separate uplink beam indication, the corresponding N bits may be used. However, for the DCI used for the separate uplink beam indication, values of the corresponding last N bits may be used. It should be noted that the TCI field of the DCI is not limited to the above description. For example, in some embodiments, the first M bits indicate the uplink beam, while the last N bits indicate the downlink beam.

Mode III, the DCI is received, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In this embodiment, the terminal may receive the separate beam indication information through the DCI. In case that there is a need for a beam indication, it is possible to first determine whether a currently activated TCI state (for example, the TCI state activated by the previously sent MAC CE) is available. In case that there is a currently available activated TCI state, the terminal may only receive the DCI from the network device, so as to determine the beam information according to the DCI. The first indication field of the DCI includes the first field portion indicating one TCI state, corresponding to the beam that may be used for uplink transmission, and/or one TCI state, corresponding to the beam that may be used for downlink transmission, in the plurality of activated TCI states. where a specific example of the DCI may refer to the above description.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In this embodiment, the first indication field of the DCI may include the first field portion and the second field portion, where the second field portion is used as an identifier for identifying that the TCI state indicated by the first field portion corresponds to which one of the beam that may be used for downlink and also uplink transmission, the beam that may be used for downlink transmission, and the beam that may be used for uplink transmission. In response to the beam indication information being the separate beam indication information, the second field portion indicates that the TCI state indicated by the first field portion corresponds to the beam that may be used for downlink transmission or the beam that may be used for uplink transmission.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

For example, the DCI includes a TCI field which includes a plurality of bits for indicating one TCI state. A bit number is a maximum of a bit number for indicating one TCI state corresponding to the beam that may be used for uplink transmission, and a bit number for indicating one TCI state corresponding to the beam that may be used for downlink transmission. In addition, the TCI field includes a plurality of bits used as identifiers. The existing DCI format 1_1 and DCI format 1_2 may be reused. In one example, the TCI field of the DCI is fixed to include T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission. That is to say, the T bits are used as the identifiers to identify max (M, N) bits indicating that TCI state corresponds to which one of the beam that may be used for downlink transmission and also uplink transmission, the beam that may be used for downlink transmission, and the beam that may be used for uplink transmission. In a case that the network device transmits the separate beam indication information through the MAC CE and the DCI, the T identifiers indicate the separate uplink beam indication or the separate downlink beam indication. For the DCI used for the separate downlink beam indication, the T identifiers indicate the separate downlink beam indication, while the max (M, N) bits indicate the TCI state corresponding to the beam that may be used for downlink transmission. For the DCI used for the separate uplink beam indication, the T identifiers indicate the separate uplink beam indication, while the max (M, N) bits indicate the TCI state corresponding to the beam that may be used for uplink transmission.

In S1404, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S1405, determine the beam information based on the uplink and downlink beam indication mode and the beam indication information.

In response to determining that the beam indication information is received, the beam information is determined according to the uplink and downlink beam indication mode and the beam indication information.

It should be noted that an execution order of the above steps is not limited to the that in this embodiment.

In the beam determination method according to this embodiment, by configuring the beam-related information based on the RRC configuration signaling, in which the TCI state configuration information includes the identifier used for distinguishing the serving cell and the adjacent cell, the beam of the adjacent cell can be indicated for the terminal. Thus, in case that the beam performance of the adjacent cell is good, the adjacent cell can provide a service for the terminal, and a throughput of the terminal is increased. In addition, the uplink and downlink beam indication mode is determined by receiving the beam indication information by at least one of the MAC CE or the DCI based on the beam indication solution indicating that the data channel and the control channel share the same beam information. The beam information is determined according to the beam indication information and the uplink and downlink beam indication mode, so that the beam determination method that may be used in a case that the data channel and the control channel share the common beam indication is provided.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

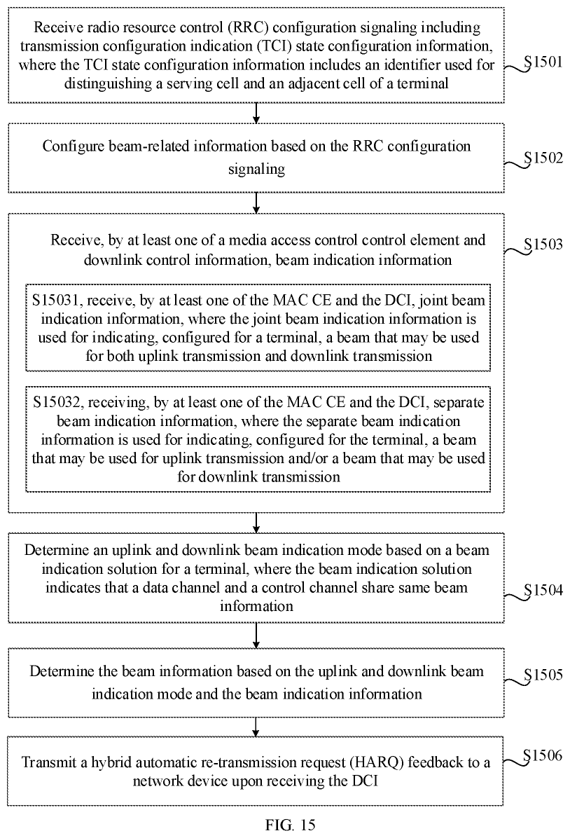

FIG. 15 is a flow chart of a beam determination method according to an embodiment of the present disclosure. In this embodiment, the method is executed by a terminal. As shown in FIG. 15, the beam determination method includes the following steps S1501-S1506.

In S1501, receive radio resource control (RRC) configuration signaling including transmission configuration indication (TCI) state configuration information, where the TCI state configuration information includes an identifier used for distinguishing a serving cell and an adjacent cell of a terminal

In this embodiment, in order to distinguish the serving cell and the adjacent cell, the network device may introduce a new parameter upon using the RRC configuration signaling to configure the TCI state, and this new parameter is used for distinguishing the serving cell and the adjacent cell. Thus, the terminal may receive the RRC configuration signaling, in which the TCI state configuration information includes the identifier used for distinguishing the serving cell and the adjacent cell of the terminal.

In some embodiments, the identifier includes a physical cell identify (PCI) of the adjacent cell.

In S1502, configure beam-related information based on the RRC configuration signaling.

In response to determining that the terminal has received the RRC configuration signaling, in which the TCI state configuration information includes the identifier used for distinguishing the serving cell and the adjacent cell of the terminal, the beam-related information is configured based on the RRC configuration signaling.

In S1503, receive, by at least one of a media access control control element (MAC CE) or downlink control information (DCI), beam indication information, where the beam indication information indicates a beam configured for the terminal.

In this embodiment, the terminal may receive the beam indication information from the network device at least through the MAC CE and/or the DCI.

In some examples, the receiving beam indication information of S1503 may include any of the following steps S15031 and S15032.

In S15031, receive, by at least one of the MAC CE or the DCI, joint beam indication information, where the joint beam indication information is used for indicating, configured for the terminal, a beam that may be used for both uplink transmission and downlink transmission.

In this embodiment, the terminal may receive the joint beam indication information used for indicating the beam that may be used for both uplink transmission and downlink transmission from the network device.

In some examples, the joint beam indication information may be received by any of the following modes.

Mode I, the MAC CE is received. Where the MAC CE indicates one TCI state which corresponds to the beam that may be used for both uplink transmission and downlink transmission.

Mode II, the MAC CE and the DCI are received, where the MAC CE indicates a plurality of TCI states, and a first indication field of the DCI includes a first field portion indicating one TCI state, corresponding to the beam that may be used for both uplink transmission and downlink transmission, in the plurality of TCI states.

Mode III, the DCI is received, where the first indication field of the DCI includes a first field portion indicating one TCI state, corresponding to the beam that may be used for both uplink transmission and downlink transmission, in the plurality of activated TCI states.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

In S15032, receive, by at least one of the MAC CE or the DCI, separate beam indication information, where the separate beam indication information is used for indicating, configured for the terminal, a beam that may be used for uplink transmission and/or a beam that may be used for downlink transmission.

In this embodiment, the terminal may receive the separate beam indication information used for indicating the beam that may be used for uplink transmission, and/or the beam that may be used for downlink transmission from the network device.

In some examples, the separate beam indication information may be received by any of the following modes.

Mode I, at least one MAC CE is received. Where the at least one MAC CE includes a first MAC CE indicating one TCI state which corresponds to the beam that may be used for uplink transmission, and/or a second MAC CE indicating one TCI state which corresponds to the beam that may be used for downlink transmission.

Mode II, at least one MAC CE and the DCI are received, where the at least one MAC CE indicates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states.

In some embodiments, at least one MAC CE indicating the plurality of TCI states includes: a third MAC CE indicating the plurality of TCI states corresponding to the beam that may be used for uplink transmission and corresponding to the beam that may be used for downlink transmission.

In some embodiments, at least one MAC CE indicating the plurality of TCI states includes: a fourth MAC CE indicating the plurality of TCI states corresponding to the beam that may be used for uplink transmission and a fifth MAC CE indicating the plurality of TCI states corresponding to the beam that may be used for downlink transmission.

Mode III, the DCI is received, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the first indication field, received by the terminal, of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number is a maximum of a bit number for indicating one TCI state corresponding to the beam that may be used for uplink transmission, and a bit number for indicating one TCI state corresponding to the beam that may be used for downlink transmission.

The above steps S15031 and S15032 correspond to steps S14031 and S14032 shown in FIG. 14 respectively. Therefore, the specific contents of steps S15031 and S15032 may refer to the above description of steps S14031 and S14032, which will not be described any more.

In S1504, determine an uplink and downlink beam indication mode based on a beam indication solution for the terminal, where the beam indication solution indicates that a data channel and a control channel share same beam information.

In the communication system, the beam indication solution may be detected for the terminal. The beam indication solution may, for example, represent how the data channel and the control channel use the beam information, for example, using the respective beam information or sharing the same beam information.

In this embodiment, the beam indication solution may indicate that the data channel and the control channel share the same beam information. In some embodiments, the beam indication solution is a unified TCI framework.

In this embodiment, based on the beam indication solution for the terminal, the terminal may determine the uplink and downlink beam indication mode. For example, through high layer signaling, the uplink and downlink beam indication mode may include: a joint uplink and downlink beam indication, separate uplink beam indication and/or separate downlink beam indication. Among them, the separate uplink beam indication and/or separate downlink beam indication may include at least one of a separate uplink beam indication or a separate downlink beam indication.

In some embodiments, the network device may notify the uplink and downlink beam indication mode to the terminal through the high layer signaling. That is, information identifying the uplink and downlink beam indication mode may be included in the high layer signaling. The high layer signaling may be signaling of other layers, for example, an RRC layer, a MAC layer or the like, except a physical layer. In other embodiments, the network device does not notify the uplink and downlink beam indication mode to the terminal through the high layer signaling; and then, the terminal may determine its corresponding uplink and downlink beam indication mode according to the received beam indication information.

In S1505, determine the beam information based on the uplink and downlink beam indication mode and the beam indication information.

In response to determining that the beam indication information is received, the beam information is determined according to the uplink and downlink beam indication mode and the beam indication information.

In S1506, transmit a hybrid automatic re-transmission request (HARQ) feedback to a network device upon receiving the DCI.

In response to determining that the beam indication information including the DCI is received, the terminal may transmit a corresponding hybrid automatic re-transmission request (HARQ) feedback to the network device, so as to notify the network device that the DCI has been received.

It should be noted that an execution order of the above steps is not limited to the above description.

In the beam determination method according to this embodiment, by configuring the beam-related information based on the RRC configuration signaling, in which the TCI state configuration information includes the identifier used for distinguishing the serving cell and the adjacent cell, the beam of the adjacent cell can be indicated for the terminal. Thus, in case that the beam performance of the adjacent cell is good, the adjacent cell can provide a service for the terminal, and a throughput of the terminal is increased. In addition, the uplink and downlink beam indication mode is determined by receiving the beam indication information by at least one of the MAC CE or the DCI based on the beam indication solution indicating that the data channel and the control channel share the same beam information; the beam information is determined according to the beam indication information and the uplink and downlink beam indication mode; and an HARQ message is fed back after the DCI is received, so that the network device can know whether the terminal receives the DCI.

In some embodiments, the network device is a communication device in a serving cell of the terminal or in an adjacent cell of the serving cell.

In this embodiment, the beam indication information may be sent by a device in the serving cell of the terminal, or by a device in the adjacent cell adjacent to the serving cell.

By corresponding to the beam indication methods provided by the above several embodiments, the present disclosure further provides a beam indication apparatus. The beam indication apparatuses provided by the embodiments of the present disclosure corresponds to the beam indication methods provided by the above several embodiments. Therefore, implementations of the beam indication methods are also applicable to the beam indication apparatus provided by this embodiment, and will not be described in detail in this embodiment.

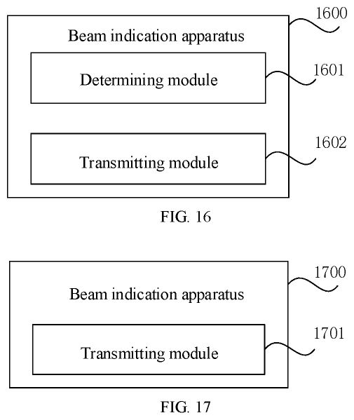

FIG. 16 is a schematic structural diagram of a beam indication apparatus provided by an embodiment of the present disclosure. The device is applied to the network device. As shown in FIG. 16, the beam indication apparatus 1600 includes a determining module 1601 and a transmitting module 1602.

The determining module 1601 is configured to determine an uplink and downlink beam indication mode based on a beam indication solution for a terminal, where the beam indication solution indicates that a data channel and a control channel share same beam information.

The transmitting module 1602 is configured to transmit, by at least one of a media access control control element (MAC CE) or DCI, the beam indication information to the terminal based on the uplink and downlink beam indication mode, where the beam indication information indicates a beam configured for the terminal.

For the beam indication apparatus according to this embodiment, the uplink and downlink beam indication mode is determined based on the beam indication solution indicating that the data channel and the control channel share the same beam information. The beam indication information is sent by at least one of the MAC CE or the DCI based on the uplink and downlink beam indication mode, so that a beam indication method that may be used in a case that the data channel and the control channel share the common beam indication is provided.

In some embodiments, the beam indication solution is a unified transmission configuration indication (TCI) framework.

In some embodiments, the transmitting module 1602 is configured to transmit the solution indication information to the terminal, where the solution indication information indicates the beam indication solution.

In some embodiments, the transmitting module 1602 is configured to: transmit, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission; or transmit, by at least one of the MAC CE or the DCI, separate beam indication information to the terminal in response to the uplink and downlink beam indication mode being separate uplink beam indication and/or separate downlink beam indication, where the separate beam indication information is used for indicating, configured for the terminal, a beam that may be used for uplink transmission and/or a beam that may be used for downlink transmission.

In some embodiments, the transmitting module 1602 is configured to: transmit the MAC CE to the terminal, where the MAC CE activates one TCI state which corresponds to the beam that may be used for both uplink transmission and downlink transmission; or transmit the MAC CE and the DCI to the terminal, where the MAC CE activates a plurality of TCI states, and a first indication field of the DCI includes a first field portion indicating one TCI state, corresponding to the beam that may be used for both uplink transmission and downlink transmission, in the plurality of TCI states; or transmit the DCI to the terminal, where the first indication field of the DCI includes a first field portion indicating one TCI state, corresponding to the beam that may be used for both uplink transmission and downlink transmission, in the plurality of activated TCI states.

In some embodiments, the transmitting module 1602 is configured to: transmit at least one MAC CE to the terminal, where the at least one MAC CE includes a first MAC CE activating one TCI state which corresponds to the beam that may be used for uplink transmission, and/or a second MAC CE activating one TCI state which corresponds to the beam that may be used for downlink transmission; or transmit at least one MAC CE and the DCI to the terminal, where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or transmit the DCI to the terminal, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

In some embodiments, the first indication field of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

In some embodiments, the first indication field of the DCI includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

In some embodiments, the solution indication information further includes: information used for identifying a control resource set CORESET adapting to the beam indication solution.

In some embodiments, the network device is a communication device in a serving cell of the terminal or in an adjacent cell of the serving cell.

FIG. 17 is a schematic structural diagram of a beam indication apparatus 1700 provided by an embodiment of the present disclosure. The device is applied to the network device. As shown in FIG. 17, the beam indication apparatus 1700 includes a transmitting module 1701.

The transmitting module 1701 is configured to transmit radio resource control (RRC) configuration signaling, including transmission configuration indication (TCI) state configuration information, to the terminal, where the TCI state configuration information includes an identifier used for distinguishing the serving cell and the adjacent cell of the terminal.

For the beam indication apparatus 1700 according to this embodiment, by including the identifier differentiating the serving cell and the adjacent cell in the TCI state configuration information of the RRC configuration signaling, the beam of the adjacent cell can be indicated for the terminal. Thus, in case that the beam performance of the adjacent cell is good, the adjacent cell can provide a service for the terminal, and a throughput of the terminal is increased.

In some embodiments, the identifier includes a physical cell identify (PCI) of the adjacent cell.

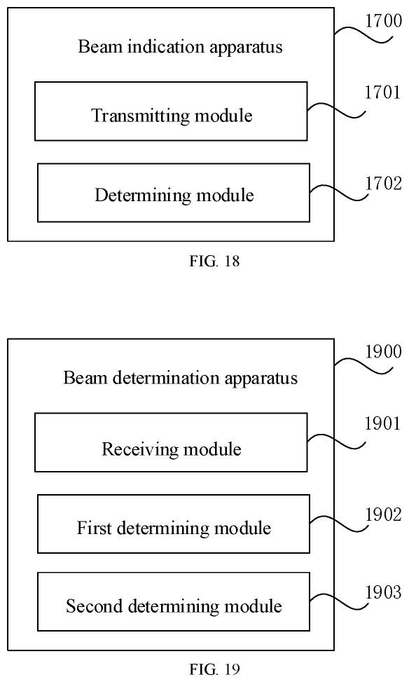

FIG. 18 is a schematic structural diagram of the beam indication apparatus 1700 provided by an embodiment of the present disclosure. The apparatus is applied to the network device.

On the basis of the beam indication apparatus as shown in FIG. 17, the apparatus 1700 as shown in FIG. 18 includes the transmitting module 1701 and further includes a determining module 1702. The determining module 1702 is configured to determine an uplink and downlink beam indication mode based on a beam indication solution for a terminal, where the beam indication solution indicates that a data channel and a control channel share same beam information.

The transmitting module 1701 is further configured to transmit, by at least one of a media access control control element (MAC CE) or downlink control information (DCI), beam indication information to the terminal based on the uplink and downlink beam indication mode, where the beam indication information indicates a beam configured for the terminal.

In some embodiments, the beam indication solution is a unified transmission configuration indication (TCI) framework.

In some embodiments, the transmitting module 1701 is configured to transmit the solution indication information to the terminal, where the solution indication information indicates the beam indication solution.

In some embodiments, the transmitting module 1701 is configured to: transmit, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission; or transmit, by at least one of the MAC CE or the DCI, separate beam indication information to the terminal in response to the uplink and downlink beam indication mode being separate uplink beam indication and/or separate downlink beam indication, where the separate beam indication information is used for indicating, configured for the terminal, a beam that may be used for uplink transmission and/or a beam that may be used for downlink transmission.

In some embodiments, the transmitting module 1701 is configured to: transmit the MAC CE to the terminal, where the MAC CE activates one TCI state which corresponds to the beam that may be used for both uplink transmission and downlink transmission; or transmit the MAC CE and the DCI to the terminal, where the MAC CE activates a plurality of TCI states, and a first indication field of the DCI includes a first field portion indicating one TCI state, corresponding to the beam that may be used for both uplink transmission and downlink transmission, in the plurality of TCI states; or transmit the DCI to the terminal, where the first indication field of the DCI includes a first field portion indicating one TCI state, corresponding to the beam that may be used for both uplink transmission and downlink transmission, in the plurality of activated TCI states.

In some embodiments, the transmitting module 1701 is configured to: transmit at least one MAC CE to the terminal, where the at least one MAC CE includes a first MAC CE activating one TCI state which corresponds to the beam that may be used for uplink transmission, and/or a second MAC CE activating one TCI state which corresponds to the beam that may be used for downlink transmission; or transmit at least one MAC CE and the DCI to the terminal, where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or transmit the DCI to the terminal, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

In some embodiments, the first indication field of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

In some embodiments, the first indication field of the DCI includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

In some embodiments, the solution indication information further includes: information used for identifying a control resource set CORESET adapting to the beam indication solution.

In some embodiments, the network device is a communication device in a serving cell of the terminal or in an adjacent cell of the serving cell.

By corresponding to the beam determination methods provided by the above several embodiments, the present disclosure further provides a beam determination apparatus. The beam determination apparatuses provided by the embodiments of the present disclosure corresponds to the beam determination methods provided by the above several embodiments. Therefore, implementations of the determination of the beam indication are also applicable to the beam determination apparatus provided by this embodiment, and will not be described in detail in this embodiment.

FIG. 19 is a schematic structural diagram of a beam determination apparatus provided by an embodiment of the present disclosure. The apparatus is applied to the terminal. As shown in FIG. 19, the beam determination apparatus 1900 includes: a receiving module 1901, a first determining module 1902, and a second determining module 1903.

The receiving module 1901 is configured to receive, by at least one of a media access control control element (MAC CE) or downlink control information (DCI), beam indication information, where the beam indication information indicates a beam configured for the terminal.

The first determining module 1902 is configured to determine an uplink and downlink beam indication mode based on a beam indication solution for a terminal, where the beam indication solution indicates that a data channel and a control channel share same beam information.

The second determining module 1903 is configured to determine the beam information based on the uplink and downlink beam indication mode and the beam indication information.

For the beam determination apparatus 1900 according to this embodiment, the uplink and downlink beam indication mode is determined by receiving the beam indication information by at least one of the MAC CE or the DCI based on the beam indication solution indicating that the data channel and the control channel share the same beam information; and the beam information is determined according to the beam indication information and the uplink and downlink beam indication mode, so that the beam determination method that may be used in a case that the data channel and the control channel share the common beam indication is provided.

In some embodiments, the beam indication solution is a unified transmission configuration indication (TCI) framework.

In some embodiments, the receiving module 1901 is configured to receive the solution indication information, where the solution indication information indicates the beam indication solution.

In some embodiments, the receiving module 1901 is configured to: receive, by at least one of the MAC CE or the DCI, joint beam indication information, where the joint beam indication information is used for indicating, configured for the terminal, a beam that may be used for both uplink transmission and downlink transmission; or receive, by at least one of the MAC CE or the DCI, separate beam indication information, where the separate beam indication information is used for indicating, configured for the terminal, a beam that may be used for uplink transmission and/or a beam that may be used for downlink transmission.

In some embodiments, the receiving module 1901 is configured to: receive the MAC CE, where the MAC CE activates one TCI state which corresponds to the beam that may be used for both uplink transmission and downlink transmission; or receive the MAC CE and the DCI, where the MAC CE activates a plurality of TCI states, and a first indication field of the DCI includes a first field portion indicating one TCI state, corresponding to the beam that may be used for both uplink transmission and downlink transmission, in the plurality of TCI states; or receive the DCI, where the first indication field of the DCI includes a first field portion indicating one TCI state, corresponding to the beam that may be used for both uplink transmission and downlink transmission, in the plurality of activated TCI states.

In some embodiments, the receiving module 1901 is configured to: receive at least one MAC CE, where the at least one MAC CE includes a first MAC CE activating one TCI state which corresponds to the beam that may be used for uplink transmission, and/or a second MAC CE activating one TCI state which corresponds to the beam that may be used for downlink transmission; or receive at least one MAC CE and the downlink control information (DCI), where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or receive the DCI, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

In some embodiments, the first indication field of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

In some embodiments, the first indication field of the DCI includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

In some embodiments, the solution indication information further includes: information used for identifying a control resource set CORESET adapting to the beam indication solution.

In some embodiments, the network device is a communication device in a serving cell of the terminal or in an adjacent cell of the serving cell.

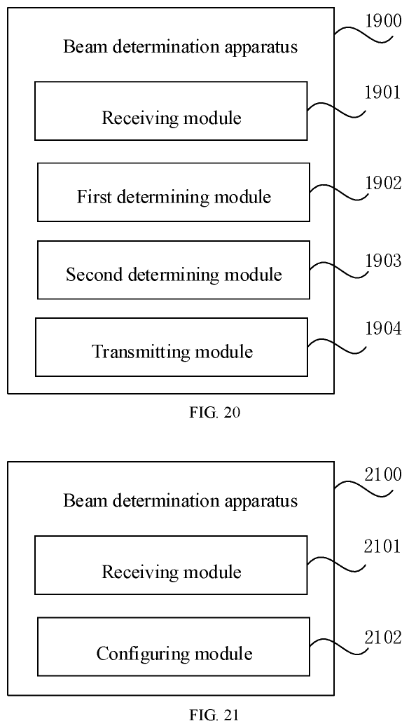

FIG. 20 is a schematic structural diagram of a beam determination apparatus 1900 provided by an embodiment of the present disclosure. The apparatus is applied to the terminal.

On the basis of the beam determination apparatus as shown in FIG. 19, the apparatus 1900 as shown in FIG. 20 includes the receiving module 1901, to first determining module 1902, and the second determining module 1903 and further includes a transmitting module 1904. The transmitting module 1904 is configured to transmit a hybrid automatic re-transmission request (HARQ) feedback to the network device upon receiving the DCI from the network device.

FIG. 21 is a schematic structural diagram of a beam determination apparatus 2100 provided by an embodiment of the present disclosure. The apparatus is applied to the terminal. As shown in FIG. 21, the beam determination apparatus 2100 includes a receiving module 2101 and a configuring module 2102.

The receiving module 2101 is configured to receive RRC configuration signaling including transmission configuration indication (TCI) state configuration information, where the TCI state configuration information includes an identifier used for distinguishing a serving cell and an adjacent cell of the terminal.

The configuring module 2102 is configured to configure beam-related information based on the RRC configuration signaling.

For the beam determination apparatus according to this embodiment, by configuring the beam-related information based on the RRC configuration signaling, in which the TCI state configuration information includes the identifier used for distinguishing the serving cell and the adjacent cell, the beam of the adjacent cell can be indicated for the terminal. Thus, in case that the beam performance of the adjacent cell is good, the adjacent cell can provide a service for the terminal, and a throughput of the terminal is increased.

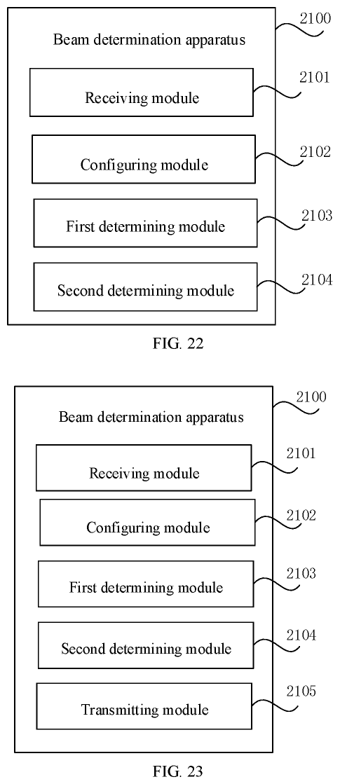

FIG. 22 is a schematic structural diagram of a beam determination apparatus 2100 provided by an embodiment of the present disclosure. The apparatus is applied to the terminal.

On the basis of the beam determination apparatus as shown in FIG. 21, the apparatus 2100 as shown in FIG. 22 includes the receiving module 2101 and the configuring module 2102, and further includes a first determining module 2103 and a second determining module 2104.

The receiving module 2101 is further configured to receive, by at least one of a media access control control element (MAC CE) or downlink control information (DCI), beam indication information, where the beam indication information indicates a beam configured for the terminal.

The first determining module 2103 is configured to determine an uplink and downlink beam indication mode based on a beam indication solution for a terminal, where the beam indication solution indicates that a data channel and a control channel share same beam information.

The second determining module 2104 is configured to determine the beam information based on the uplink and downlink beam indication mode and the beam indication information.

In some embodiments, the beam indication solution is a unified transmission configuration indication (TCI) framework.

In some embodiments, the receiving module 2101 is configured to receive the solution indication information, where the solution indication information indicates the beam indication solution.

In some embodiments, the receiving module 2101 is configured to: receive, by at least one of the MAC CE or the DCI, joint beam indication information, where the joint beam indication information is used for indicating, configured for the terminal, a beam that may be used for both uplink transmission and downlink transmission; or receive, by at least one of the MAC CE or the DCI, separate beam indication information, where the separate beam indication information is used for indicating, configured for the terminal, a beam that may be used for uplink transmission and/or a beam that may be used for downlink transmission.

In some embodiments, the receiving module 2101 is configured to: receive the MAC CE, where the MAC CE activates one TCI state which corresponds to the beam that may be used for both uplink transmission and downlink transmission; or receive the MAC CE and the DCI, where the MAC CE activates a plurality of TCI states, and a first indication field of the DCI includes a first field portion indicating one TCI state, corresponding to the beam that may be used for both uplink transmission and downlink transmission, in the plurality of TCI states; or receive the DCI, where the first indication field of the DCI includes a first field portion indicating one TCI state, corresponding to the beam that may be used for both uplink transmission and downlink transmission, in the plurality of activated TCI states.

In some embodiments, the receiving module 2101 is configured to: receive at least one MAC CE, where the at least one MAC CE includes a first MAC CE activating one TCI state which corresponds to the beam that may be used for uplink transmission, and/or a second MAC CE activating one TCI state which corresponds to the beam that may be used for downlink transmission; or receive at least one MAC CE and the downlink control information (DCI), where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or receive the DCI, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

In some embodiments, the at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

In some embodiments, the first indication field of the DCI further includes: a second field portion indicating the uplink and downlink beam indication mode, where the uplink and downlink beam indication mode is one of the joint uplink and downlink beam indication, a separate uplink beam indication and a separate downlink beam indication.

In some embodiments, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

In some embodiments, the first indication field of the DCI includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

In some embodiments, the solution indication information further includes: information used for identifying a control resource set CORESET adapting to the beam indication solution.

In some embodiments, the network device is a communication device in a serving cell of the terminal or in an adjacent cell of the serving cell.

FIG. 23 is a schematic structural diagram of a beam determination apparatus 2100 provided by an embodiment of the present disclosure. The apparatus is applied to the terminal.

On the basis of the beam determination apparatus as shown in FIG. 22, the apparatus 2100 as shown in FIG. 23 includes the receiving module 2101, the configuring module 2102, the first determining module 2103 and the second determining module 2104, and further includes: a transmitting module 2105. The transmitting module 2105 is configured to transmit a hybrid automatic re-transmission request (HARQ) feedback to the network device upon receiving the DCI from the network device.

According to the embodiments of the present disclosure, the present disclosure further provides a communication device and a computer-readable storage medium.

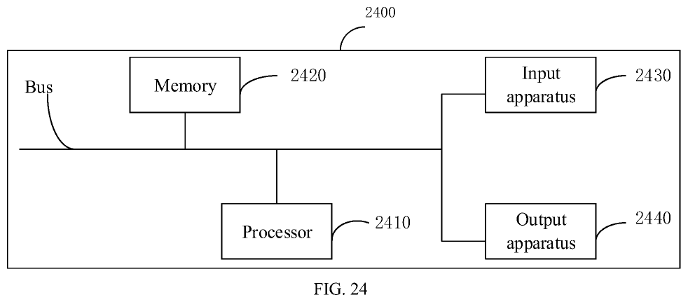

As shown FIG. 24, is a block diagram of a communication device 2400 according to an embodiment of the present disclosure. The communication device 2400 is intended to represent digital computers in various forms, such as a laptop computer, a desktop computer, a workstation, a personal digital assistant, a server, a blade server, a mainframe computer, and other suitable computers. The communication device may further represent mobile apparatuses in various forms, such as a personal digital assistant, a cellular phone, a smart phone, a wearable device, and other similar computing apparatuses. The components shown herein, their connections and relationships, and their functions are merely examples, and are not intended to limit the implementation of the present disclosure described and/or required herein.

As shown in FIG. 24, the communication device 2400 includes: one or more processors 2410, a memory 2420, and interfaces (not shown) used for connecting various components, including high-speed interfaces and low-speed interfaces. The components are connected with each other by virtue of different buses, and may be installed on a common motherboard or may be installed in other manners as needed. The processor 2410 may process instructions executed within the communication device, including instructions stored in the memory 2420 or on the memory to display graphical information of a GUI on an external input/output apparatus (such as a display device coupled to an interface). In other implementation manners, a plurality of the processors 2410 and/or a plurality of the buses may be used together with a plurality of the memories 2420 as needed. Similarly, a plurality of the communication devices 2400 may be connected, and each device provides part of necessary operations (such as serving as a server array, a set of blade servers, or a multi-processor system). One processor 2410 is taken as an example in FIG. 24.

The memory 2420 is a non-instantaneous computer-readable storage medium provided by the present disclosure. Among them, instructions that may be executed by at least one processor 2410 are stored in the memory 2420, so that the at least one processor 2410 executes the beam indication method and the beam determination method provided by the present disclosure. Computer instructions are stored in the non-instantaneous computer-readable storage medium of the present disclosure, and used for enabling a computer to execute the beam indication method provided by the present disclosure.

As a non-instantaneous computer-readable storage medium, the memory 2420 may be used for storing non-instantaneous software programs, non-instantaneous computer-executable programs, and modules, such as program instructions/modules corresponding to the beam indication method and the beam determination method in the embodiments of the present disclosure. By running the non-instantaneous software programs, instructions, and modules stored in the memory 2420, the processor 2410 executes various functional applications and data processing of a server, that is, realizes the beam indication method and the beam determination method in the above method embodiments.

The memory 2420 may include a program storage area and a data storage area, where application programs required by an operating system and at least one function may be stored in the program storage area; and data created according to usage of a positioning communication device, etc. may be stored in the data storage area. In addition, the memory 2420 may include a high-speed random access memory, and may further include a non-instantaneous memory, such as at least one magnetic disk storage device, a flash memory device, or other non-instantaneous solid-state storage devices. Optionally, the memory 2420 may include memories which are remotely arranged relative to the processor 2410, and the remote memories may be connected to the positioning communication device through a network. Examples of the above network include, but are not limited to, the Internet, an enterprise Internet, a local area network, a mobile communication network, and combinations thereof.

The communication device 2400 may further include: an input apparatus 2430 and output apparatus 2440. The processor 2410, the memory 2420, the input apparatus 2430 and the output apparatus 2440 may be connected with each other through buses or other manners. In FIG. 24, bus connection is taken as an example.

The input apparatus 2430 may receive input digital or character information, and generate key signal input related to user setting and function control of the positioning communication device, and may be a touch screen, a keypad, a mouse, a trackpad, a touchpad, an indicator rod, one or more mouse buttons, a trackball, a joystick, etc. The output apparatus 2440 may include a display device, an auxiliary illumination apparatus (such as an LED), a tactile feedback apparatus (such as a vibration motor), etc. The display device may include, but is not limited to, a liquid crystal display (LCD), a light-emitting diode (LED) display, and a plasma display. In some implementation manners, the display device may be a touch screen.

The implementation manners of the systems and technologies described herein may be realized in a digital electronic circuit system, an integrated circuit system, a dedicated ASIC (application-specific integrated circuit), computer hardware, firmware, software, and/or combinations thereof. The implementation manners may include: being implemented in one or more computer programs, the one or more computer programs may be executed and/or interpreted in a programmable system including at least one programmable processor, and the programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

The computing programs (also known as programs, software, software applications, or codes) include machine instructions of the programmable processor, and may be implemented by virtue of an advanced process and/or an object-oriented programming language, and/or an assembly/machine language. As used therein, the terms ‘machine-readable medium’ and ‘computer-readable medium’ refer to any computer program products, devices, and/or apparatuses (such as magnetic disks, optical disks, memories, and programmable logic apparatuses (PLDs)) used for providing the machine instructions and/or data to the programmable processor, and include machine-readable mediums that receive the machine instructions which are taken as machine-readable signals. The term ‘machine-readable signal’ refers to any signal used for providing the machine instructions and/or data to the programmable processor.

In order to provide interaction with a user, the systems and technologies described herein may be implemented in a computer, the computer is provided with: a display apparatus (such as a CRT (cathode ray tube) or an LCD (liquid crystal display) monitor) used for displaying information to the user; and a keyboard and a pointing apparatus (such as a mouse or a trackball), and the user may provide input to the computer through the keyboard and the pointing apparatus. Other types of apparatuses may also be used for providing interaction with the user; for example, feedback provided to the user may be sensory feedback in any form (such as visual feedback, auditory feedback, or tactile feedback); and the input of the user may be received in any form (including vocal input, speech input, or tactile input).

The systems and technologies described herein may be implemented in a computing system (for example, as a data server) including a background component, or a computing system (for example, an application server) including a middleware component, or a computing system (for example, a user computer with a graphical user interface or a web browser through which the user may interact with the implementation manners of the systems and technologies described herein) including a front-end component, or a computing system including any combination of the background component, the middleware component, or the front-end component. The components of the system may be connected with each other through digital data communication (for example, a communication network) in any form or medium. Examples of the communication network include: a local area network (LAN), a wide area network (WAN), and the Internet.

The computer system may include a client and a server. The client and the server are generally far away from each other and usually interact through the communications network. A relationship between the client and the server is generated by computer programs running in respective computers and having a client-server relationship with each other.

The steps provided herein may be reordered, added, or deleted by using the flows in various forms, which are shown above. For example, the steps recorded in the present disclosure may be performed concurrently, in order, or in a different order, provided that the desired result of the technical solutions disclosed in the present disclosure can be achieved, which is not limited herein.

The above specific implementation manners do not constitute a limitation on the scope of protection of the present disclosure. Those skilled in the art will understand that, various modifications, combinations, sub-combinations, and substitutions may be made according to design requirements and other factors. Any modifications, equivalent substitutions, and improvements made within the spirit and principles of the present disclosure should be included within the scope of protection of the present disclosure.

The present application discloses a beam indication method and apparatus, and a beam determination method and apparatus, and provides a beam indication method that may be used in a case that a data channel and a control channel share a common beam indication and a method for indicating a beam of an adjacent cell for a terminal. Therefore, in case that the beam performance of the adjacent cell is good, the adjacent cell can provide a service for the terminal, and a throughput of the terminal is increased.

In a first aspect of the present disclosure, the embodiment provides a beam indication method, applied to a network device and including: determining an uplink and downlink beam indication mode based on a beam indication solution for a terminal, where the beam indication solution indicates that a data channel and a control channel share same beam information; and transmitting, by at least one of a media access control control element (MAC CE) or downlink control information (DCI), the beam indication information to the terminal based on the uplink and downlink beam indication mode, where the beam indication information indicates a beam configured for the terminal.

Optionally, the beam indication solution is a unified transmission configuration indication (TCI) framework.

Optionally, the method further includes: transmitting solution indication information to the terminal, where the solution indication information indicates the beam indication solution.

Optionally, transmitting, by at least one of a MAC CE or DCI, the beam indication information to the terminal based on the uplink and downlink beam indication mode includes: transmitting, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission; or transmitting, by at least one of the MAC CE or the DCI, separate beam indication information to the terminal in response to the uplink and downlink beam indication mode being separate uplink beam indication and/or separate downlink beam indication, where the separate beam indication information is used for indicating, configured for the terminal, a beam that may be used for uplink transmission and/or a beam that may be used for downlink transmission.

Optionally, transmitting, by at least one of the MAC CE or the DCI, joint beam indication information to the terminal includes: transmitting the MAC CE to the terminal, where the MAC CE activates one TCI state which corresponds to the beam that may be used for both uplink transmission and downlink transmission; or transmitting the MAC CE and the DCI to the terminal, where the MAC CE activates a plurality of TCI states, and a first indication field of the DCI includes a first field portion indicating one TCI state, corresponding to the beam that may be used for both uplink transmission and downlink transmission, in the plurality of TCI states; or transmitting the DCI to the terminal, where the first indication field of the DCI includes a first field portion indicating one TCI state, corresponding to the beam that may be used for both uplink transmission and downlink transmission, in the plurality of activated TCI states.

Optionally, transmitting, by at least one of the MAC CE or the DCI, separate beam indication information to the terminal includes: transmitting at least one MAC CE to the terminal, where the at least one MAC CE includes a first MAC CE activating one TCI state which corresponds to the beam that may be used for uplink transmission, and/or a second MAC CE activating one TCI state which corresponds to the beam that may be used for downlink transmission; or transmitting at least one MAC CE and the DCI to the terminal, where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or transmitting the DCI to the terminal, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

Optionally, at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

Optionally, the first indication field further includes: a second field portion indicating the uplink and downlink beam indication mode, where the uplink and downlink beam indication mode is one of the joint uplink and downlink beam indication, a separate uplink beam indication and a separate downlink beam indication.

Optionally, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

Optionally, the first indication field includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

Optionally, the solution indication information further includes: information used for identifying a control resource set CORESET adapting to the beam indication solution.

Optionally, the network device is a communication device in a serving cell of the terminal or in an adjacent cell of the serving cell.

In a second aspect of the present disclosure, the embodiment provides a beam indication method, applied to a network device and including: transmitting radio resource control (RRC) configuration signaling, including transmission configuration indication (TCI) state configuration information, to the terminal, where the TCI state configuration information includes an identifier used for distinguishing the serving cell and the adjacent cell of the terminal.

Optionally, the identifier includes a physical cell identify (PCI) of the adjacent cell.

Optionally, the method further includes: determining an uplink and downlink beam indication mode based on a beam indication solution for the terminal, where the beam indication solution indicates that a data channel and a control channel share same beam information; and transmitting, by at least one of a media access control control element (MAC CE) or downlink control information (DCI), the beam indication information to the terminal based on the uplink and downlink beam indication mode, where the beam indication information indicates a beam configured for the terminal.

Optionally, the beam indication solution is a unified transmission configuration indication (TCI) framework.

Optionally, the method further includes: transmitting solution indication information to the terminal, where the solution indication information indicates the beam indication solution.

Optionally, transmitting, by at least one of a MAC CE or DCI, the beam indication information to the terminal based on the uplink and downlink beam indication mode includes: transmitting, by at least one of the MAC CE or the DCI, joint beam indication information to the terminal in response to the uplink and downlink beam indication mode being a joint uplink and downlink beam indication, where the joint beam indication information is used for indicating, configured for the terminal, a beam that may be used for both uplink transmission and downlink transmission; or transmitting, by at least one of the MAC CE or the DCI, separate beam indication information to the terminal in response to the uplink and downlink beam indication mode being separate uplink beam indication and/or separate downlink beam indication, where the separate beam indication information is used for indicating, configured for the terminal, a beam that may be used for uplink transmission and/or a beam that may be used for downlink transmission.

Optionally, transmitting, by at least one of the MAC CE or the DCI, joint beam indication information to the terminal includes: transmitting the MAC CE to the terminal, where the MAC CE activates one TCI state which corresponds to the beam that may be used for both uplink transmission and downlink transmission; or transmitting the MAC CE and the DCI to the terminal, where the MAC CE activates a plurality of TCI states, and a first indication field of the DCI includes a first field portion indicating one TCI state, corresponding to the beam that may be used for both uplink transmission and downlink transmission, in the plurality of TCI states; or transmitting the DCI to the terminal, where the first indication field of the DCI includes a first field portion indicating one TCI state, corresponding to the beam that may be used for both uplink transmission and downlink transmission, in the plurality of activated TCI states.

Optionally, transmitting, by at least one of the MAC CE or the DCI, separate beam indication information to the terminal includes: transmitting at least one MAC CE to the terminal, where the at least one MAC CE includes a first MAC CE activating one TCI state which corresponds to the beam that may be used for uplink transmission, and/or a second MAC CE activating one TCI state which corresponds to the beam that may be used for downlink transmission; or transmitting at least one MAC CE and the DCI to the terminal, where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or transmitting the DCI to the terminal, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

Optionally, at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

Optionally, the first indication field further includes: a second field portion indicating the uplink and downlink beam indication mode, where the uplink and downlink beam indication mode is one of the joint uplink and downlink beam indication, a separate uplink beam indication and a separate downlink beam indication.

Optionally, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

Optionally, the first indication field includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

Optionally, the solution indication information further includes: information used for identifying a control resource set CORESET adapting to the beam indication solution.

Optionally, the network device is a communication device in a serving cell of the terminal or in an adjacent cell of the serving cell.

In a third aspect of the present disclosure, the embodiment provides a beam determination method, applied to a terminal and including: receiving, by at least one of a media access control control element (MAC CE) or downlink control information (DCI), beam indication information, where the beam indication information indicates a beam configured for the terminal; determining an uplink and downlink beam indication mode based on a beam indication solution for the terminal, where the beam indication solution indicates that a data channel and a control channel share same beam information; and determining the beam information based on the uplink and downlink beam indication mode and the beam indication information.

Optionally, the beam indication solution is a unified transmission configuration indication (TCI) framework.

Optionally, the method further includes: receiving solution indication information, where the solution indication information indicates the beam indication solution.

Optionally, receiving, by at least one of a MAC CE or DCI, beam indication information includes: receiving, by at least one of the MAC CE or the DCI, joint beam indication information, where the joint beam indication information is used for indicating, configured for the terminal, a beam that may be used for both uplink transmission and downlink transmission; or receiving, by at least one of the MAC CE or the DCI, separate beam indication information, where the separate beam indication information is used for indicating, configured for the terminal, a beam that may be used for uplink transmission and/or a beam that may be used for downlink transmission.

Optionally, receiving, by at least one of the MAC CE or the DCI, joint beam indication information includes: receiving the MAC CE, where the MAC CE activates one TCI state which corresponds to the beam that may be used for both uplink transmission and downlink transmission; or receiving the MAC CE and the DCI, where the MAC CE activates a plurality of TCI states, and a first indication field of the DCI includes a first field portion indicating one TCI state, corresponding to the beam that may be used for both uplink transmission and downlink transmission, in the plurality of TCI states; or receiving the DCI, where the first indication field of the DCI includes a first field portion indicating one TCI state, corresponding to the beam that may be used for both uplink transmission and downlink transmission, in the plurality of activated TCI states.

Optionally, receiving, by at least one of the MAC CE or the DCI, separate beam indication information includes: receiving at least one MAC CE, where the at least one MAC CE includes a first MAC CE activating one TCI state which corresponds to the beam that may be used for uplink transmission, and/or a second MAC CE activating one TCI state which corresponds to the beam that may be used for downlink transmission; or receiving at least one MAC CE and the downlink control information (DCI), where at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or receiving the DCI, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

Optionally, at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

Optionally, the first indication field further includes: a second field portion indicating the uplink and downlink beam indication mode, where the uplink and downlink beam indication mode is one of the joint uplink and downlink beam indication, a separate uplink beam indication and a separate downlink beam indication.

Optionally, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

Optionally, the first indication field includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

Optionally, the solution indication information further includes: information used for identifying a control resource set CORESET adapting to the beam indication solution.

Optionally, the method further includes: transmitting a hybrid automatic re-transmission request (HARQ) feedback to the network device upon receiving the DCI from the network device.

In a fourth aspect of the present disclosure, the embodiment provides a beam determination method, applied to a terminal and including: receiving RRC configuration signaling including transmission configuration indication (TCI) state configuration information, where the TCI state configuration information includes an identifier used for distinguishing a serving cell and an adjacent cell of the terminal; and configuring beam-related information based on the RRC configuration signaling.

Optionally, the identifier includes a physical cell identify (PCI) of the adjacent cell.

Optionally, the method further includes: receiving, by at least one of a media access control control element (MAC CE) or downlink control information (DCI), beam indication information, where the beam indication information indicates a beam configured for the terminal; determining an uplink and downlink beam indication mode based on a beam indication solution for the terminal, where the beam indication solution indicates that a data channel and a control channel share same beam information; and determining the beam information based on the uplink and downlink beam indication mode and the beam indication information.

Optionally, the beam indication solution is a unified transmission configuration indication (TCI) framework.

Optionally, the method further includes: receiving solution indication information, where the solution indication information indicates the beam indication solution.

Optionally, receiving, by at least one of a MAC CE or DCI, beam indication information includes: receiving, by at least one of the MAC CE or the DCI, joint beam indication information, where the joint beam indication information is used for indicating, configured for the terminal, a beam that may be used for both uplink transmission and downlink transmission; or receiving, by at least one of the MAC CE or the DCI, separate beam indication information, where the separate beam indication information is used for indicating, configured for the terminal, a beam that may be used for uplink transmission and/or a beam that may be used for downlink transmission.

Optionally, receiving, by at least one of the MAC CE or the DCI, joint beam indication information includes: receiving the MAC CE, where the MAC CE activates one TCI state which corresponds to the beam that may be used for both uplink transmission and downlink transmission; or receiving the MAC CE and the DCI, where the MAC CE activates a plurality of TCI states, and a first indication field of the DCI includes a first field portion indicating one TCI state, corresponding to the beam that may be used for both uplink transmission and downlink transmission, in the plurality of TCI states; or receiving the DCI, where the first indication field of the DCI includes a first field portion indicating one TCI state, corresponding to the beam that may be used for both uplink transmission and downlink transmission, in the plurality of activated TCI states.

Optionally, receiving, by at least one of the MAC CE or the DCI, separate beam indication information includes: receiving at least one MAC CE, where the at least one MAC CE includes a first MAC CE activating one TCI state which corresponds to the beam that may be used for uplink transmission, and/or a second MAC CE activating one TCI state which corresponds to the beam that may be used for downlink transmission; or receiving at least one MAC CE and the downlink control information (DCI), where the at least one MAC CE activates a plurality of TCI states, and a first indication field of the DCI includes a first field portion indicating one TCI state, corresponding to the beam that may be used for uplink transmission, and/or one TCI state, corresponding to the beam that may be used for downlink transmission, in the plurality of TCI states; or receiving the DCI, where the first indication field of the DCI includes a first field portion indicating one TCI state, corresponding to the beam that may be used for uplink transmission, and/or one TCI state, corresponding to the beam that may be used for downlink transmission, in the plurality of activated TCI states.

Optionally, at least one MAC CE activating the plurality of activated TCI states includes: a third MAC CE activating the plurality of TCI states corresponding to the beam that may be used for uplink transmission and the plurality of TCI states corresponding to the beam that may be used for downlink transmission; or a fourth MAC CE activating the plurality of TCI states corresponding to the beam that may be used for uplink transmission, and a fifth MAC CE activating the plurality of TCI states corresponding to the beam that may be used for downlink transmission.

Optionally, the first indication field further includes: a second field portion indicating the uplink and downlink beam indication mode, where the uplink and downlink beam indication mode is one of the joint uplink and downlink beam indication, a separate uplink beam indication and a separate downlink beam indication.

Optionally, the first field portion includes a plurality of bits, where a bit number of the plurality of bits is a maximum of a bit number for indicating one TCI state corresponding to the beam that may be used for uplink transmission, and a bit number for indicating one TCI state corresponding to the beam that may be used for downlink transmission.

Optionally, the first indication field includes: T+max (M, N) bits, where T indicates a bit number used as the second field portion; M indicates a bit number for indicating one TCI state corresponding to the beam that may be used for uplink transmission; and N indicates a bit number for indicating one TCI state corresponding to the beam that may be used for downlink transmission.

Optionally, the solution indication information further includes: information used for identifying a control resource set CORESET adapting to the beam indication solution.

Optionally, the method further includes: transmitting a hybrid automatic re-transmission request (HARQ) feedback to the network device upon receiving the DCI from the network device.

In a fifth aspect of the present disclosure, the embodiment provides a beam indication apparatus, applied to a network device and including: a determining module, configured to determine an uplink and downlink beam indication mode based on a beam indication solution for a terminal, where the beam indication solution indicates that a data channel and a control channel share same beam information; and a transmitting module, configured to transmit, by at least one of a media access control control element (MAC CE) or downlink control information (DCI), the beam indication information to the terminal based on the uplink and downlink beam indication mode, where the beam indication information indicates a beam configured for the terminal.

In a sixth aspect of the present disclosure, the embodiment provides a beam indication apparatus, applied to a network device and including: a transmitting module, configured to transmit RRC configuration signaling, including transmission configuration indication (TCI) state configuration information, to the terminal, where the TCI state configuration information includes an identifier used for distinguishing a serving cell and an adjacent cell of the terminal.

In a seventh aspect of the present disclosure, the embodiment provides a beam determination apparatus, applied to a terminal and including: a receiving module, configured to receive, by at least one of a media access control control element (MAC CE) or downlink control information (DCI), beam indication information, where the beam indication information indicates a beam configured for the terminal; a first determining module, configured to determine an uplink and downlink beam indication mode based on a beam indication solution for the terminal, where the beam indication solution indicates that a data channel and a control channel share same beam information; and a second determining module, configured to determine the beam information based on the uplink and downlink beam indication mode and the beam indication information.

In an eighth aspect of the present disclosure, the embodiment provides a beam determination apparatus, applied to a terminal and including: a receiving module, configured to receive RRC configuration signaling including transmission configuration indication (TCI) state configuration information, where the TCI state configuration information includes an identifier used for distinguishing a serving cell and an adjacent cell of the terminal; and a configuring module, configured to configure beam-related information based on the RRC configuration signaling.

In a ninth aspect of the present disclosure, the embodiment provides a communication device, including: a transceiver, a memory, and a processor which is connected to the transceiver and the memory respectively, is configured to control radio signal transceiving of the transceiver by executing computer-executable instructions on the memory, and implements the beam indication method provided according to the embodiment in the first aspect, or the embodiment in the second aspect, or the embodiment in the third aspect, or the embodiment in the fourth aspect.

In a tenth aspect of the present disclosure, the embodiment provides a non-transitory computer-readable storage medium for storing computer-executable instructions, where after the computer-executable instructions are executed by a processor, the beam indication method provided according to the embodiment in the first aspect, or the embodiment in the second aspect, or the embodiment in the third aspect, or the embodiment in the fourth aspect is implemented.

For the beam indication method and apparatus and the beam determination method and apparatus provided by the embodiments of the present disclosure, the uplink and downlink beam indication mode is determined based on the beam indication solution indicating that the data channel and the control channel share the same beam information; and the beam indication information is sent by at least one of the MAC CE or the DCI based on the uplink and downlink beam indication mode, so that the beam indication method that may be used in a case that the data channel and the control channel share the common beam indication is provided. In addition, by including the identifier differentiating the serving cell and the adjacent cell in the TCI state configuration information of the RRC configuration signaling, the beam of the adjacent cell can be indicated for the terminal, so that in case that the beam performance of the adjacent cell is good, the adjacent cell can provide a service for the terminal, and a throughput of the terminal is increased.

1. A beam indication method, performed by a network device, the method comprising:
determining an uplink and downlink beam indication mode based on a beam indication solution for a terminal, wherein the beam indication solution indicates that a data channel and a control channel share same beam information; and
transmitting, by at least one of a media access control control element (MAC CE) or downlink control information (DCI), the beam indication information to the terminal based on the uplink and downlink beam indication mode, wherein the beam indication information indicates a beam configured for the terminal.

2. (canceled)

3. The method according to claim 1, further comprising:
transmitting solution indication information to the terminal, wherein the solution indication information indicates the beam indication solution.

4. The method according to claim 1, wherein transmitting, by the at least one of the MAC CE or the DCI, the beam indication information to the terminal based on the uplink and downlink beam indication mode comprises:
transmitting, by at least one of the MAC CE or the DCI, joint beam indication information to the terminal by determining that to the uplink and downlink beam indication mode is a joint uplink and downlink beam indication, wherein the joint beam indication information is used for indicating a beam, configured for the terminal, used for both an uplink transmission and a downlink transmission; or
transmitting, by at least one of the MAC CE or the DCI, separate beam indication information to the terminal by determining that the uplink and downlink beam indication mode is at least one of a separate uplink bean indication or a separate downlink beam indication, wherein the separate beam indication information is used for indicating at least one of an uplink beam, configured for the terminal, used for the uplink transmission or a downlink beam, configured for the terminal, used for the downlink transmission.

5. The method according to claim 4, wherein
transmitting, by the at least one of the MAC CE or the DCI, joint beam indication information to the terminal comprises at least one of the following:
transmitting the MAC CE to the terminal, wherein the MAC CE activates one transmission configuration indication (TCI) state which corresponds to the beam used for both the uplink transmission and the downlink transmission;
transmitting the MAC CE and the DCI to the terminal, wherein the MAC CE activates a plurality of TCI states, and a first indication field of the DCI comprises a first field portion indicating one TCI state, corresponding to the beam used for both the uplink transmission and the downlink transmission, in the plurality of TCI states; or
transmitting the DCI to the terminal, wherein the first indication field of the DCI comprises the first field portion indicating one TCI state, corresponding to the beam used for both the uplink transmission and the downlink transmission, in the plurality of activated TCI states;
or
transmitting, by the at least one of the MAC CE or the DCI, the separate beam indication information to the terminal comprises at least one of the following:
transmitting the at least one of the MAC CE to the terminal, wherein the at least one of the MAC CE comprises at least one of a first MAC CE or a second MAC CE, the first MAC CE activating one TCI state which corresponds to the uplink beam, the second MAC CE activating one TCI state which corresponds to the downlink;
transmitting the at least one of the MAC CE or the DCI to the terminal, wherein the at least one of the MAC CE activates a plurality of TCI states, and the first indication field of the DCI comprises the first field portion indicating at least one of the plurality of TCI states, corresponding to the uplink beam, or one TCI state, corresponding to the downlink beam, in the plurality of TCI states; or
transmitting the DCI to the terminal, wherein the first indication field of the DCI comprises the first field portion indicating at least one of the plurality of TCI states, corresponding to the uplink beam, or one TCI state, corresponding to the download beam, in the plurality of activated TCI states.

6-12. (canceled)

13. The method according to claim 1, the method further comprising:
transmitting radio resource control (RRC) configuration signaling, comprising transmission configuration indication (TCI) state configuration information, to the terminal, wherein the TCI state configuration information comprises an identifier used for distinguishing a serving cell of the terminal and an adjacent cell of the terminal.

14-26. (canceled)

27. A beam determination method, performed by a terminal, and the method comprises:
receiving, by at least one of a media access control control element (MAC CE) or downlink control information (DCI), beam indication information, wherein the beam indication information indicates a beam configured for the terminal;
determining an uplink and downlink beam indication mode based on a beam indication solution for the terminal, wherein the beam indication solution indicates that a data channel and a control channel share beam information; and
determining the beam information based on the uplink and downlink beam indication mode and the beam indication information.

28. The method according to claim 27, wherein the beam indication solution is a unified transmission configuration indication (TCI) framework.

29. The method according to claim 27, further comprising:
receiving solution indication information, wherein the solution indication information indicates the beam indication solution.

30. The method according to claim 27, wherein receiving, by the at least one of the MAC CE or the DCI, the beam indication information comprises:
receiving, by the at least one of the MAC CE or the DCI, joint beam indication information, wherein the joint beam indication information is used for indicating a beam, configured for the terminal, used for both an uplink transmission and a downlink transmission; or
receiving, by the at least one of the MAC CE or the DCI, separate beam indication information, wherein the separate beam indication information is used for indicating at least one of an uplink beam, configured for the terminal, used for the uplink transmission or a downlink beam, configured for the terminal, used for the downlink transmission.

31. The method according to claim 30, wherein
receiving, by the at least one of the MAC CE or the DCI, the joint beam indication information comprises at least one of the following:
receiving the MAC CE, wherein the MAC CE activates one TCI state which corresponds to the beam used for both the uplink transmission and the downlink transmission;
receiving the MAC CE and the DCI, wherein the MAC CE activates a plurality of TCI states, and a first indication field of the DCI comprises a first field portion indicating one TCI state, corresponding to the beam used for both the uplink transmission and the downlink transmission, in the plurality of TCI states; or
receiving the DCI, wherein the first indication field of the DCI comprises the first field portion indicating one TCI state, corresponding to the beam used for both the uplink transmission and the downlink transmission, in the plurality of TCI states;
or
receiving, by the at least one of the MAC CE or the DCI, the separate beam indication information comprises at least one of the following:
receiving the at least one MAC CE, wherein the at least one MAC CE comprises at least one of a first MAC CE or a second MAC CE, the first MAC CE activating one TCI state which corresponds to the uplink beam, the second MAC CE activating one TCI state which corresponds to the downlink beam;
receiving the at least one MAC CE or the DCI, wherein the at least one MAC CE activates a plurality of TCI states, and the first indication field of the DCI comprises the first field portion indicating at least one of the plurality of TCI states, corresponding to the uplink beam, or one TCI state, corresponding to the downlink beam, in the plurality of TCI states; or
receiving the DCI, wherein the first indication field of the DCI comprises the first field portion indicating at least one of the plurality of TCI states, corresponding to the uplink beam, or one TCI state, corresponding to the downlink beam, in the plurality of activated TCI states.

32. (canceled)

33. The method according to claim 31, wherein the at least one MAC CE activating the plurality of activated TCI states comprises:
a third MAC CE activating the plurality of TCI states corresponding to the uplink beam and the plurality of TCI states corresponding to the downlink beam; or
a fourth MAC CE activating the plurality of TCI states corresponding to the uplink beam, and a fifth MAC CE activating the plurality of TCI states corresponding to the downlink beam.

34. The method according to claim 31, wherein the first indication field further comprises: a second field portion indicating the uplink and downlink beam indication mode, wherein the uplink and downlink beam indication mode is one of the joint uplink and downlink beam indication, a separate uplink beam indication and a separate downlink beam indication.

35. The method according to claim 34, wherein the first field portion comprises: a plurality of bits, wherein a bit number of the plurality of bits is a maximum of a bit number for indicating one TCI state corresponding to the uplink beam, and a bit number for indicating one TCI state corresponding to the downlink beam.

36. The method according to claim 35, wherein the first indication field comprises: T+max (M, N) bits, wherein T indicates a bit number used as the second field portion; M indicates a bit number for indicating one TCI state corresponding to the uplink beam; and N indicates a bit number for indicating one TCI state corresponding to the downlink beam.

37. The method according to claim 29, wherein the solution indication information further comprises: information used for identifying a control resource set CORESET adapting to the beam indication solution.

38. The method according to claim 31, further comprising:
transmitting a hybrid automatic re-transmission request (HARQ) feedback to the network device upon receiving the DCI from the network device.

39. A beam determination method, performed by a terminal, and the method comprises:
receiving radio resource control (RRC) configuration signaling comprising transmission configuration indication (TCI) state configuration information, wherein the TCI state configuration information comprises an identifier used for distinguishing a serving cell of the terminal and an adjacent cell of the terminal; and
configuring beam-related information based on the RRC configuration signaling.

40. The method according to claim 39, wherein the identifier comprises a physical cell identify (PCI) of the adjacent cell.

41-56. (canceled)

57. A communication device, comprising: a transceiver; a memory; and a processor, which is connected to the transceiver and the memory respectively, is configured to control radio signal transceiving of the transceiver by executing computer executable instructions on the memory, and implements the method according to claim 1.

58. (canceled)

59. A communication device, comprising: a transceiver; a memory; and a processor, which is connected to the transceiver and the memory respectively, is configured to control radio signal transceiving of the transceiver by executing computer executable instructions on the memory, and implements the method according to claim 27.
